(19) United States
(12) Patent Application Publication
(10) Pub. No.: US 2014/0249836 A1
(43) Pub. Date: Sep. 4, 2014

(54) CLAIM DRIVEN MEDICAL EVENT SYSTEMS AND METHODS

(71) Applicants: Robert E. Moran, Redding, CT (US); Austin E. Moran, Redding, CT (US)

(72) Inventors: Robert E. Moran, Redding, CT (US); Austin E. Moran, Redding, CT (US)

(73) Assignee: PARSING DATA LLC, Redding, CT (US)

(21) Appl. No.: 14/187,584

(22) Filed: Feb. 24, 2014

Related U.S. Application Data
(60) Provisional application No. 61/771,309, filed on Mar. 1, 2013.

(51) Int. Cl. G06F 19/00

(52) U.S. Cl. CPC G06F 19/328
USPC 705/2

(57) ABSTRACT

A computer-implemented method, a system, and software include receiving information for a healthcare services event for a patient and creating a note based therein; performing an insurance Eligibility Request/Eligibility Verification by with an insurance company utilizing patient information converted into a format readable by the insurance company; receiving information as the healthcare services event is performed to complete the note, wherein the note comprises doctor supplied procedure and diagnostic content needed to create a valid insurance claim; and converting the note into an insurance claim and providing the insurance claim to the insurance company in a format readable by the insurance company; wherein the note is setup to automatically convert to the insurance claim without back-end user input or coding.

### CROSS-REFERENCE TO RELATED APPLICATION(S)

The present patent/application claims the benefit of U.S. Provisional Application No. 61/771,309, filed Mar. 1, 2023, and entitled “A CLAIM DRIVEN MEDICAL EVENT SYSTEM,” the contents of which are incorporated by reference herein.

### FIELD OF THE DISCLOSURE

The present disclosure relates generally to computer systems and methods in the healthcare field. More particularly, the present disclosure relates to medical claim processing systems and methods that closely align with the work-flow in medical practices.

### BACKGROUND OF THE DISCLOSURE

Conventionally in healthcare information management, a medical insurance claim is produced by a process (manual or automated) subsequent to the occurrence of a healthcare services event. Because of this separation, disparate problems arise in managing the relationship between the services rendered by healthcare providers and the reimbursement requests submitted by those providers to patient insurance plans. The gulf between these data-sets leads to isolated “silos” of information which can increase the likelihood of duplicate services, cloud accurate assessment of real service cost (both to the patient and to the provider), and hinder the accessibility of potentially beneficial healthcare information across providers and their patients. In this context, it would advantageous to mitigate this potentially grave isolation of information by providing a means of processing healthcare service events in the context of an insurance claim.

### BRIEF SUMMARY OF THE DISCLOSURE

In an exemplary embodiment, a computer-implemented method includes receiving information for a healthcare services event for a patient and creating a note based therein; performing an insurance Eligibility Request/Eligibility Verification by with an insurance company utilizing patient information converted into a format readable by the insurance company; receiving information as the healthcare services event is performed to complete the note, wherein the note comprises doctor supplied procedure and diagnostic content needed to create a valid insurance claim; and converting the note into an insurance claim and providing the insurance claim to the insurance company in a format readable by the insurance company; wherein the note is setup to automatically convert to the insurance claim without back-end user input or coding.

In another exemplary embodiment, a system includes a network interface, a data store, and a processor, each communicatively coupled therebetween; and memory storing instructions that, when executed, cause the processor to: receive information for a healthcare services event for a patient and creating a note based therein; perform an insurance Eligibility Request/Eligibility Verification by with an insurance company utilizing patient information converted into a format readable by the insurance company; receive information as the healthcare services event is performed to complete the note, wherein the note comprises doctor supplied procedure and diagnostic content needed to create a valid insurance claim; and convert the note into an insurance claim and providing the insurance claim to the insurance company in a format readable by the insurance company; wherein the note is setup to automatically convert to the insurance claim without back-end user input or coding.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1 is a claim driven medical event system overview;

FIG. 2 is an ANSI workflow round trip overview;

FIG. 3 is an exemplary System Export/Import Module File listing;

FIG. 4 is another exemplary System Export/Import Module File listing;

FIG. 5 is a claim driven medical event system ANSI round trip workflow detailed view;

FIG. 6 is a claim driven medical event system import/export diagram;

FIG. 7 is another claim driven medical event system import/export diagram;

FIG. 8 is a detailed work-flow of patient administration;

FIG. 9 is a detailed view of insurance demographic information that goes into patient administration;

FIG. 10 is a patient list centric view of the system work-flow showing the patient list as the starting point for capturing the medical event in the context of the insurance claim;

FIG. 11 is a work-flow of the patient list;

FIG. 12 is a visit details centric view of the system work-flow;

FIG. 13 is a work-flow of visit details;

FIG. 14 is a pay options centric view of the system work-flow;

FIG. 15 is a pay options work-flow;

FIG. 16 is an integrated claim/note centric view of the system work-flow;

FIG. 17 is another view of the integrated claim/note centric view of the system work-flow;

FIG. 18 is a work-flow of the claim side of the integrated claim/note entity;

FIG. 19 is a detail view of the note side of the integrated claim/note entity;

FIG. 20 is a profit and loss centric view of the system work-flow;

FIG. 21 is a work-flow of vendors;

FIG. 22 is a work-flow of products;

FIG. 23 is a work-flow of claim bill;

FIG. 24 is a work-flow of invoices;

FIG. 25 is an accounts receivable work-flow;

FIG. 26 is a purchase order work-flow;

FIG. 27 is an accounts payable work-flow;

FIG. 28 is a lab work-flow;

FIG. 29 is an MRI/X-Ray/CT work-flow;

FIG. 30 is a claim driven medical event profit and loss (P&L) calculation engine;

FIG. 31 is a detailed view of P&L;

FIG. 32 is a work-flow diagram of conventional medical event processing with the claim aspects down on the backend;

FIG. 33 is block diagram of an exemplary implementation of a claim-driven medical event system;

FIG. 34 is a network diagram of the claim driven medical event system;

FIG. 35 is a block diagram of a server which may implement claim driven medical event system; and

FIG. 36 is a block diagram of a mobile device which may access the claim driven medical event system.

### DETAILED DESCRIPTION OF THE DISCLOSURE

In various exemplary embodiments, an event-driven computer implemented system and method is described that captures a healthcare services event in the context of an insurance claim. The insurance claim can use the American National Standards Group (ANSI) Accredited Standards Committee (ASC) X12N 270, 271, 276, 277, 278, 820, 834, 835 and 837 Healthcare Administrative Transactions specifications as its relational data persistence schema in conjunction with an execution environment able to conduct profit and loss calculations on the insurance claim data stored therein. Other embodiments of the insurance claim are also contemplate. Importantly, the event-driven computer implemented system and method records all data, including financials, with respect to a healthcare services event, reducing back-end processing such as with a biller, enabling tracking for profit and loss analysis, and the like. The event-driven computer implemented system and method can be a cloud-based system as well enabling healthcare providers to simply subscribe without requiring expensive equipment as well as integration into existing practice management systems. As described herein, the event-driven computer implemented system and method can also be referred to a claim driven medical event system in that the event is the overall visit and the insurance claim (“claim”) is tracked throughout the process along with diagnosis, treatments, etc.

By processing patient medical event information in an integrated claims/note-driven by exam date and unique claim identification, for example, the event-driven computer implemented system and method can not only produce linked medical insurance verification request and claim data in ANSI 270/837-compliant formats (or other formats), but can also record the complete medical event (including its associated verification request and claim information) in open source/common file formats such as pen source and common file formats to include, but not limited to, JSON, ANSI, txt, .xls, .xlsx, .csv, .tab, .htm, .dbf, .xml, pdf and pipe delimited text. Additionally, due to the fact the event-driven computer implemented system and method can store and collate information according to an open model based on ANSI Electronic Data Interchange formats, such an embodiment can easily share files with any other healthcare system able to process content according to these established standards.

Lastly, because the claim data-set is fully integrated into the medical event schema along with operational components such as invoices and purchase orders, accurate profit and loss calculations can be assessed against a variety of metrics including billing cycles, providers, tax periods and individual patient claims. These reports can be distributed to outside financial institutions or integrated into organizational accounting. When taken in total, the functionality of various embodiments of the event-driven computer implemented system and method described herein eliminates many data manipulation bottlenecks currently plaguing the healthcare and medical insurance industries.

The event-driven computer implemented system and method as described in various embodiments herein provides a systemic approach to capturing healthcare service data in the context of an insurance claim using ANSI standards (or other standard) and does not attempt to outline a specific software architecture to implement that utility. Simply put, the design schema shown in the following embodiments can be applied to any object/relational database and associated software stack.

Definitions—The event-driven computer implemented system and method includes novel computer implemented methods and systems for the electronic processing and handling of a medical insurance claim.

As used herein, the term “computer” refers to a machine, apparatus, or device that is capable of accepting and performing logic operations from software code. The term “software”, “software code” or “computer software” refers to any set of instructions operable to cause a computer to perform an operation. Software code may be operated on by a “rules engine” or processor. Thus, the methods and systems of the present invention may be performed by a computer based on instructions received by computer software.

The term “client device” as used herein is a type of computer which is operated by a person. Non-limiting examples of client devices may include; personal computers (PCs), workstations, laptops, tablet PCs including the iPad, cell phones including iPhones android phones and windows phones, or generally any electronic device capable of running computer software and displaying information to a user.

As used herein the term “data network” shall mean an infrastructure capable of connecting two or more client devices either using wires or wirelessly allowing them to transmit and receive data. Non-limiting examples of data networks may include the internet or wireless cellular networks.

As used herein, the term database means a digital collection of data or information. The present invention uses novel methods and processes to store, link, and modify information such as application information to be transmitted to a client device. For the purposes of the present disclosure, a database may be stored on a remote server and accessed by a client device through the internet (i.e., the database is in the cloud) or alternatively in some embodiments the database may be stored on the client device or remote computer itself (i.e., local storage).

A Note, as used in some embodiments herein, is the electronic description or document the doctor or medical provider uses to describe patient treatment to include for example; Procedures (e.g. 99203—Office Output New 30 Min: $175.00) and Diagnoses (e.g., 477 Allergic Rhinitis) along with Exam Date, a description of the exam including, when applicable, the writing up of prescriptions and requests for, lab and/or MRI/X-ray/CTs services. The Note, in some embodiments, is created before the insurance claim.

An Insurance Claim, as used in some embodiments herein, is a document such as an electronic document (e.g., the ANSI 837 document) combining patient and insurance demographic information with the Exam Date and doctor generated procedure/diagnoses data-set requesting payment from the insurance company for services rendered.

An Export/Import module, of the event-driven computer implemented system and method, uses, in some embodiments, the American National Standards Group (ANSI) Accredited Standards Committee (ASC) X12N 270, 271, 276, 277, 278, 820, 834, 835 and 837 Healthcare Administrative Transactions specifications dataset, in part, to convert output generated by the claim-driven medical event system into four open source file formats including but not limited to: JSON (Javascript Object Notation), XML, ANSI and ASCII pipe-delimited text able to 1. export ANSI 270 (Insurance Eligibility Verification Request) for patient eligibility verification and ANSI 837 (Insurance Claim) for processing claims to insurance companies and 2. import ANSI 271 (Insurance Eligibility Verification Response) to determine whether a patient is insured and ANSI 835 (Insurance Claim Response Remittance) receiving payment for services rendered from insurance companies on an as needs basis.

In the following description, details regarding the embodiment of the event-driven computer implemented system and method able to capture a “medical event” including data related to healthcare services rendered by a provider or group of providers on a given date or across a range of dates in the context of an insurance claim, including operational functionality such as profit and loss and inventory management, are described.

In some embodiments, the event-driven computer implemented system and method includes a series of computer implemented methods (sometimes called a “system”) capable of recording details surrounding a medical event using the American National Standards Group (ANSI) Accredited Standards Committee (ASC) X12N 270, 271, 276, 277, 278, 820, 834, 835 and 837 Healthcare Administrative Transactions specifications or other generally acceptable specifications as may be used in the future as its relational data persistence schema in conjunction with an execution environment able to conduct profit and loss calculations on the insurance claim and supplementary provider operational data stored therein.

The event-driven computer implemented system and method as described in various embodiments herein can be replicated on any computer or group of computers capable of running a relational database management system (RDBMS) alongside a local or distributed presentation layer such as a desktop windowing environment or web application server. The focus of this document is to outline the methodology by which an embodiment of this system can import and process healthcare information using the aforementioned ANSI formats as its transaction engine.

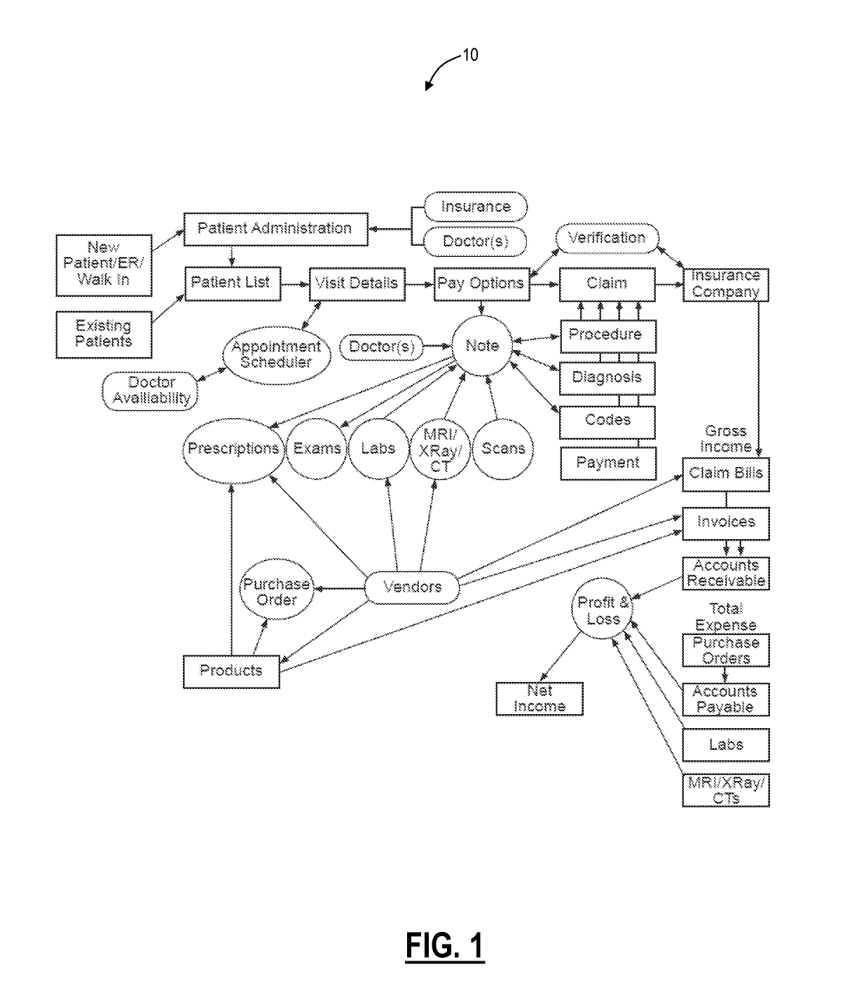

FIG. 1 shows an example of a claim driven medical event system 10 depicting how, in some embodiments, the claim-driven medical event system 10 works with various skeins of data to produce an integrated data-set of verification, claim and profit & loss content used in managing a healthcare facility. The note can include metadata that is manipulated during the medical event, by doctors, nurses, physician assistants, etc. The node can also be manipulated by third party vendors for prescriptions, exams, labs, MRI/X-Ray/CTs, scans, etc. The note is in a format, i.e. procedures, diagnosis, codes, payment, etc., that can feed directly into the claim without user intervention. In this way, the medical event directly couples the note to the claim. The claim can be transmitted to the insurance company for financial processing.

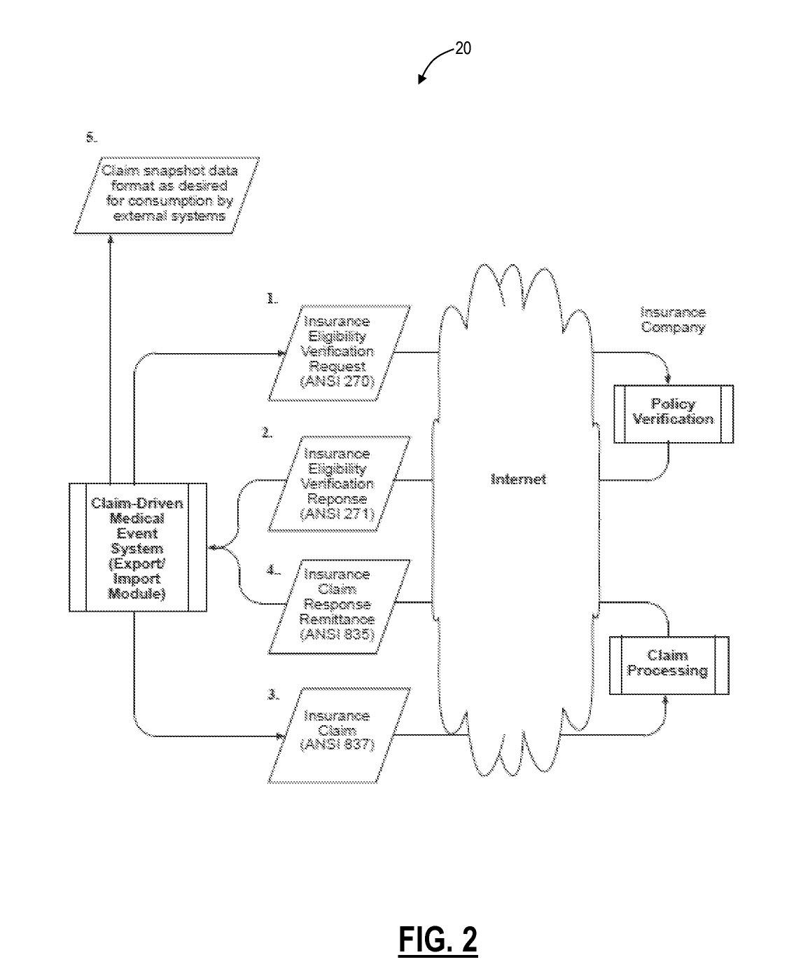

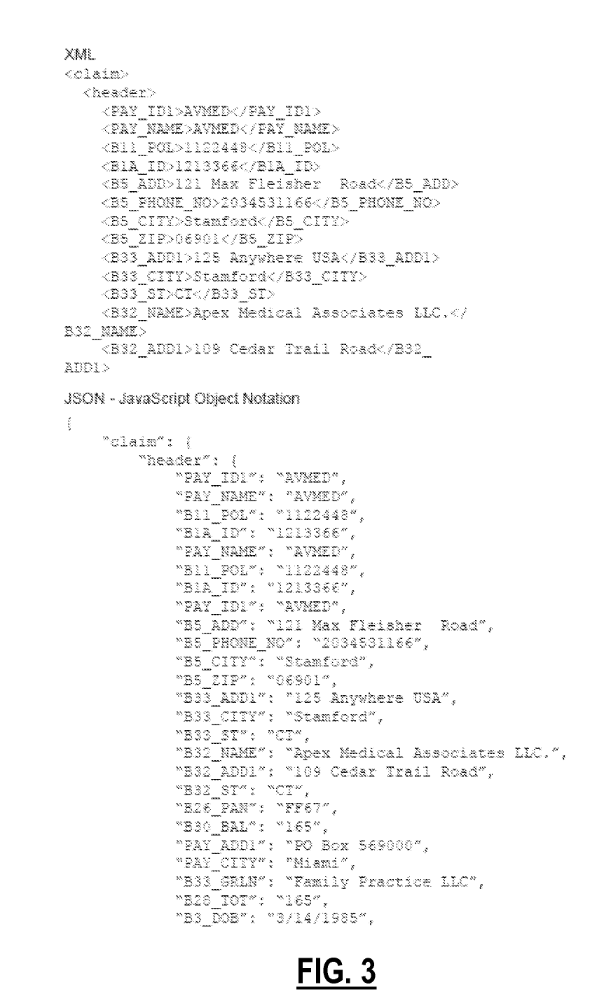

FIG. 2 depicts an example of an ANSI round trip work flow 20 showing how the embodiment of the claim driven medical event system 10 communicates with the insurance company via an Export/Import Module and the Internet to do the following: 1. Request verification as to whether the patient is eligible (e.g., ANSI 270). 2. Receive the eligibility verification response from the insurance company stating whether the patient is eligible or not (ANSI 271) 3. Submit the insurance claim (ANSI 837) to be compensated for services rendered. 4. Receive the insurance company response and remittance to the claim via ANSI 835. No. 5. identify the claim snapshot data using web compatible file formats like JSON, ANSI 837, XML and ANSI Pipe Delimited text, as needs warrant. Note: Verification may perform credit card verification, when applicable. The ANSI round trip work flow 20 shows the output and input produced by the claim driven medical event system 10, along with the Internet round-trip of that data to and from an insurance company. 1. Outgoing ANSI 270, used for patient insurance eligibility verification. 2. Incoming ANSI 271, the insurance company's response to the initial eligibility verification request. 3. Outgoing ANSI 837, used for sending out insurance claims and 4. Incoming ANSI 835, the insurance company's payment remittance data generated in response to accepted ANSI 837 claims. 5. At any time during the process, a “snapshot” of the insurance claim can be taken by the system and exported to any serializable format for which a converter has been implemented (e.g., FIG. 3). In this manner, financials are directly coupled to the medical event.

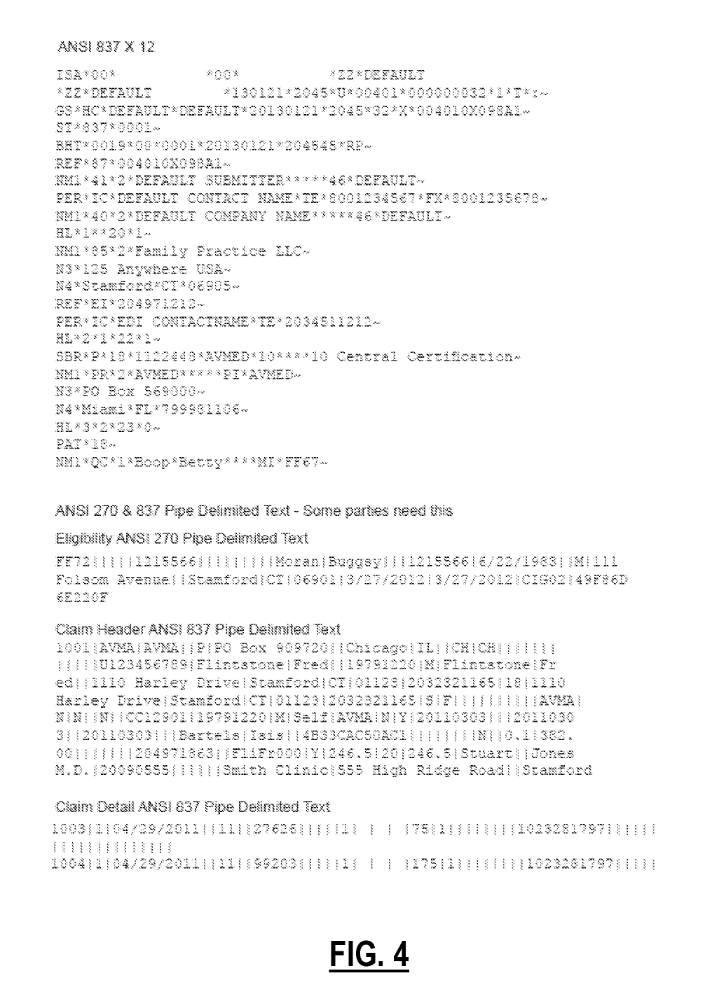

FIG. 3 shows examples of open source XML and JSON (Javascript Object Notation) files produced by some embodiments of the claim-driven medical event system 10 Export/Import Module. FIG. 4 shows examples of open source ANSI 837×12 and ASCII ANSI pipe delimited text files produced by some embodiments of the claim-driven medical event system Export/Import Module. When appropriate, the claim-driven medical event system 10 can export records in a variety of open source and common file formats including but not limited to JSON, ANSI, txt, .xls, .xlsx, .csv, .tab, .htm, .dbf, .xml, pdf and pipe delimited text.

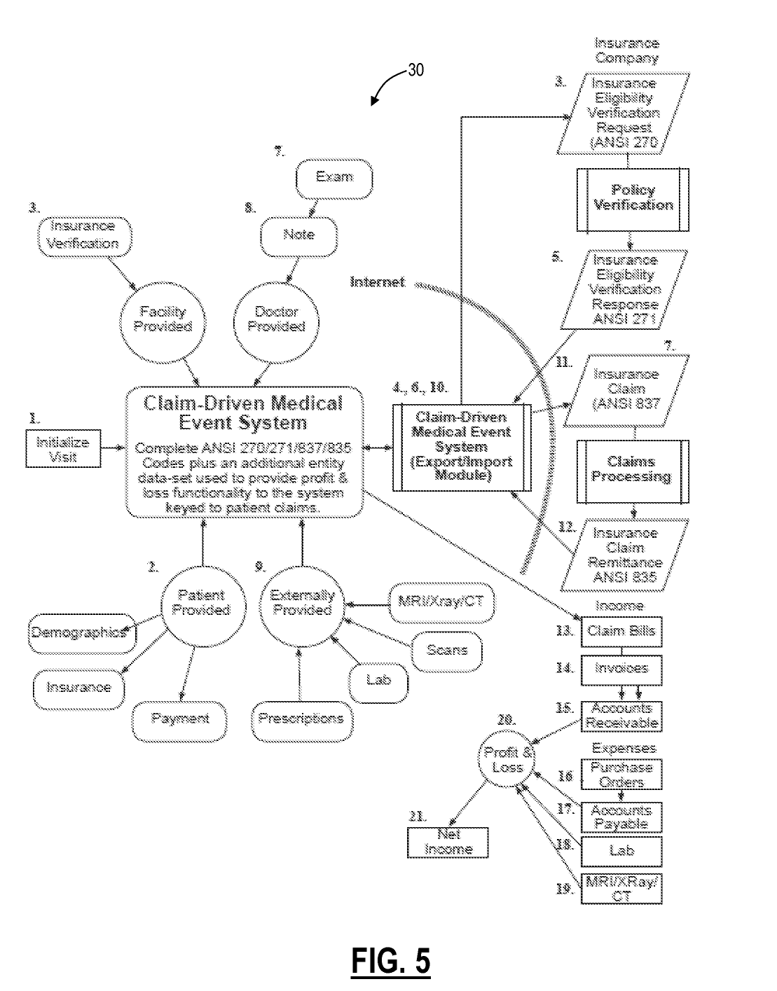

FIG. 5 illustrates an example of one complex work flow 30 of the claim-driven medical event system 10 with an ANSI Round Trip detail view. To comprehend how some embodiments of the claim-driven medical event system works requires understanding the complex work-flow involved in capturing a medical event (which may be defined generally as a patient treatment linked to an exam date, i.e. note) in the context of an insurance claim. Beginning with Initialize Visit (1.) of FIG. 5, the work-flow diagram shows how the various skeins of incoming and outgoing data-sets contribute to the creation of a claim-driven medical event. The work-flow sequence in this example, includes generally: 1. Patient initializes visit (Exam Date); 2. Patient provides demographics/health history, insurance data (insurance name, insurance number and group number and payment (copay) information to the event. Verification is requested by the facility to determine if the patient is insured; 3. The verification request is sent via an Export/Import module; 4. in ANSI 270, to the insurance company. The insurance company verifies the eligibility of the patient in ANSI 271; 5. and sends it back to the Export/Import module; 6. notifying the facility that the patient is insured; 7. Doctor exams the patient and then writes the note detailing his/her findings including procedure and diagnostic content; 8. which is a component of the integrated claim/note entity (medical event centric information—patient treatment keyed to exam date plus procedure and diagnostic content.). When applicable, the doctor specifies Prescriptions, Lab, Scans and MRI/X-rays when writing up the Note; 9. Upon completion of the Note component of the integrated claim/note entity, which includes the doctor supplied procedure and diagnostic content, the claim-driven medical event system 10 creates and sends a valid insurance claim, via the Export/Import module; 10. in ANSI 837, to the insurance company; 11. as all of the patient/insurance/copay and unique alphanumeric claim number information has already been generated when the patient shows up for the visit 1. Upon receipt of the file, the insurance company responds to the claim via ANSI 835 (insurance claim remittance); 12. and sends it back to the Export/Import module of the claim-driven medical event system 10. Once this is done, the system takes the ANSI 835 payment data and updates the profit and loss statement (Net Income) of the medical event linked insurance claim identified by its unique alphanumeric claim number by inserting this content into the Claim Bill; 13. which is the third component of the integrated Claim/Note entity. Gross Income for a medical organization, as stated before, consists of Claim Bills (the financial element of the insurance claim) plus invoices; 14. both of which are inserted into Account Receivable; 15. which, in turn, sends its data to Profit & Loss 20. to be processed. Expenses consists of Purchase Orders, 16. going into Accounts Payable 17., Lab fees 18. and MRI/X-ray/CT services 19. the content of which goes to Profit & Loss in similar fashion to Accounts Receivable to be processed. Note: The latter two are rarely considered expenses in healthcare as they send out their claims to the insurance company independently of this system's claim-driven medical event. After the content has been sent to Profit & Loss, Profit & Loss 20. subtracts the expenses of Accounts Payable, Lab and MRI/X-ray/CTs from Accounts Receivable (Claim Bills and Invoices) to arrive at 21. Net Income keyed to unique claim numbers for the organization.

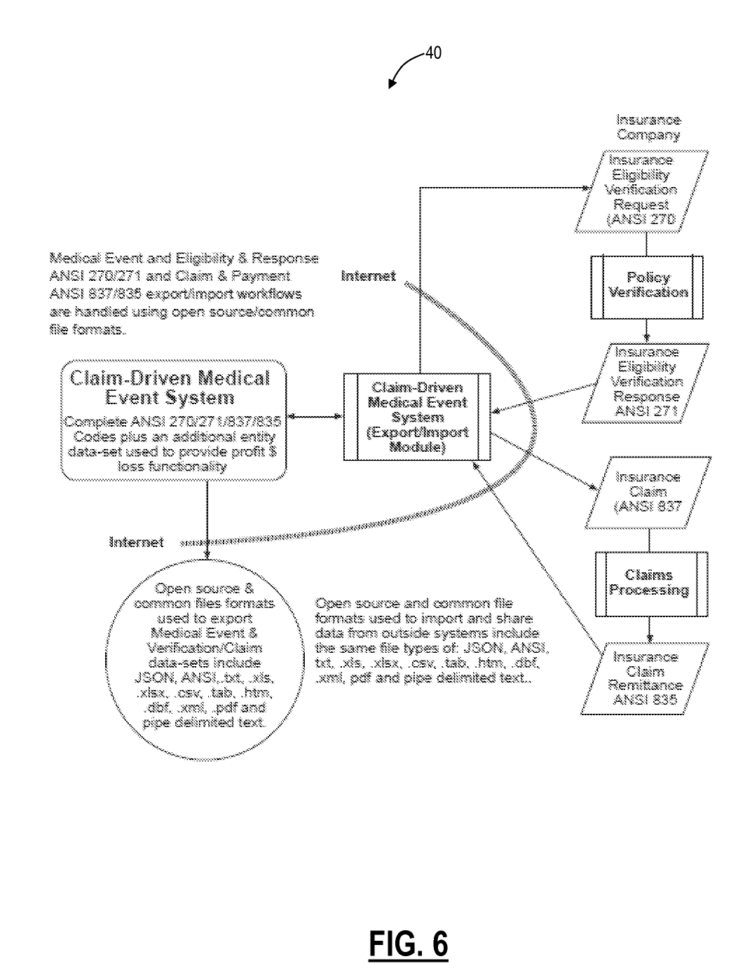

FIG. 6 shows an embodiment of the claim-driven medical event system 10 import/export environment where all data contained in the system can be exported in open source/common file formats including JSON, ANSI, txt, .xls, .xlsx, .csv, .tab, .htm, .dbf, .xml, pdf and pipe delimited text. Data shared or imported from outside systems use the same file formats of JSON, ANSI, txt, .xls, .xlsx, .csv, .tab, .htm, .dbf, .xml, pdf and pipe delimited text. In this manner, the claim-driven medical event system 10 can be integrated with existing systems, e.g. practice management systems (PMS) and the like, i.e. the claim-driven medical event system 10 can be open source.

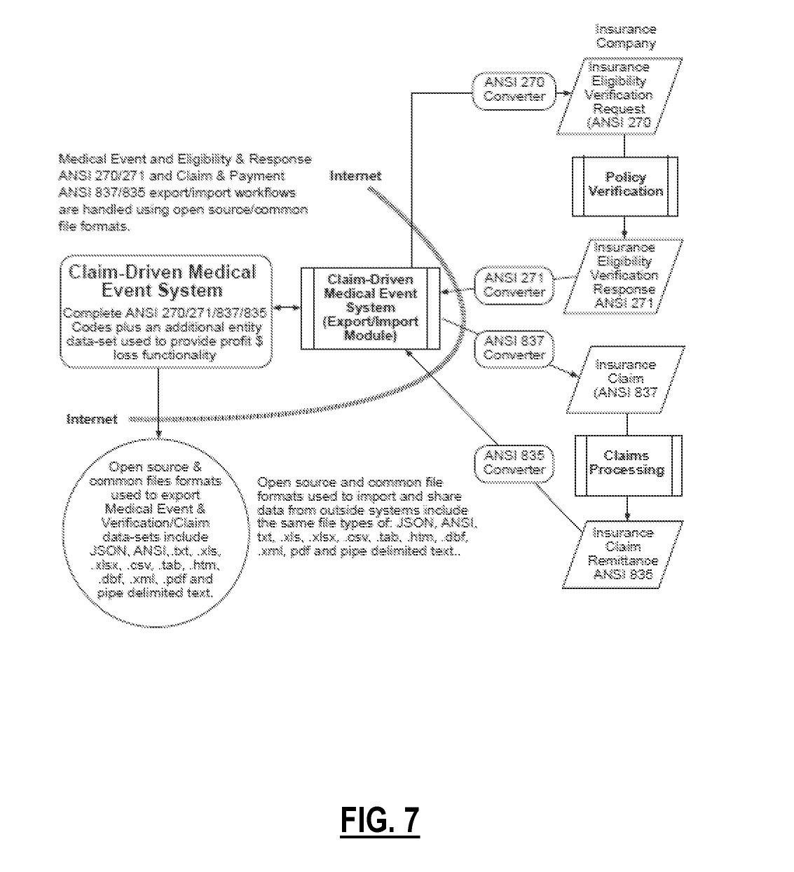

FIG. 7 shows an embodiment of the claim-driven medical event system 10 import/export environment using ANSI pipe delimited text produce via the Export/Import module, where all data contained in the system, as per FIG. 6, can be exported in open source and common file formats including JSON, ANSI, txt, .xls, .xlsx, .csv, .tab, .htm, .dbf, .xml, pdf and pipe delimited text. Data shared or imported from outside systems use the same file formats of JSON, ANSI, txt, .xls, .xlsx, .csv, .tab, .htm, .dbf, .xml, pdf and pipe delimited text; save that the only difference, in this embodiment, is that the claim-driven medical event system 10 sends the ANSI 270/271/837/835 pipe delimited text files to outside ANSI converter systems via the Export/Import Module for verification and claims processing operations with the insurance company as needs warrant.

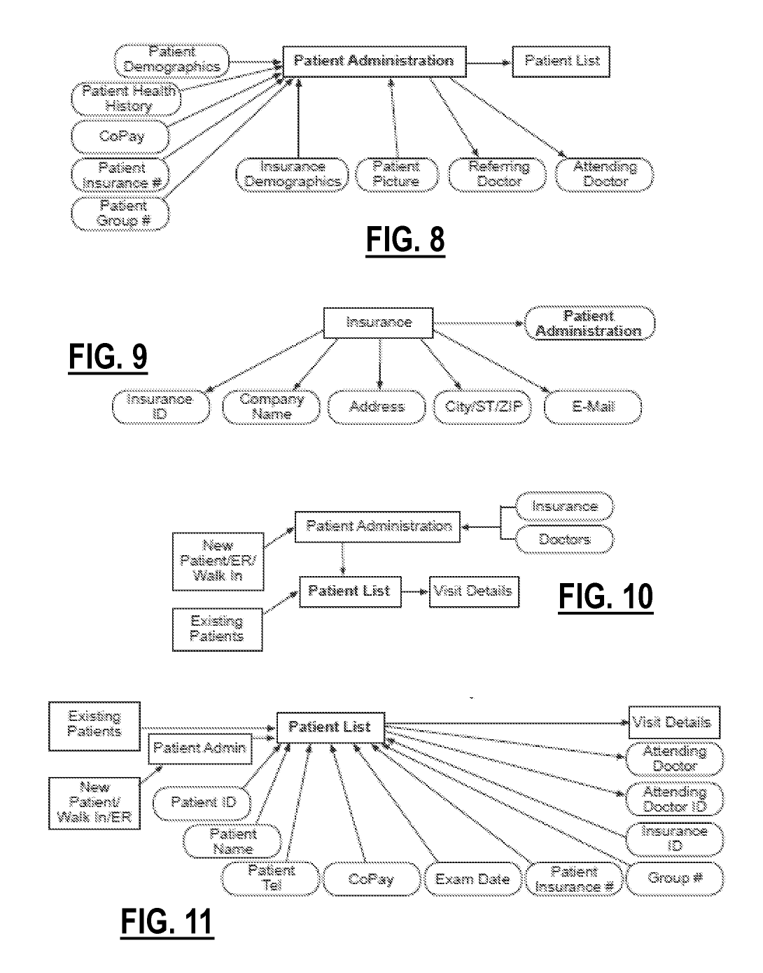

FIG. 8 shows an example of a Patient Administration work-flow, which depicts how new patient information may be imported into the claim-driven medical event system 10; this is the component of the claim-driven medical event system 10 that brings in insurance group number and insurance number, Copay, Health History, Attending Doctor and Referring Doctor, when applicable, and Patient Picture. Note: in some embodiments, the claim-driven medical event system 10 uses the same standard ANSI 837 field naming schema to insure consistency of data input, throughout the entire embodiment of the claim-driven medical event system 10.

FIG. 9 shows a detail view showing an example of how insurance demographics data is imported to the Patient Administration component of the claim-driven medical event system 10. To capture a medical event in the context of an insurance claim begins with the patient supplying demographic and insurance information to the system before treatment can begin. In the case of insurance, FIG. 9, the demographic data required includes: Insurance ID, Company Name, Address and City/State/Zip. To insure the data is properly organized, the system uses the ANSI 837 naming schema to capture this field content in accordance to standard ANSI name specification guidelines. For example, Patient ID=B26_PAN, Patient First Name=B2_FIRST, Patient Last Name=B2_LAST. As seen in FIG. 5, relevant insurance information goes into Patient Administration whenever a new or existing patient comes in for an examination.

FIG. 10 depicts an example of a patient list centric view (FIG. 1.) of the claim-driven medical event system 10 work-flow diagram delineating the Patient List as the start point for creating the medical event in the context of an insurance claim. Note: Patient list is another view of the Patient Administration entity. FIG. 10 shows an example of a start point for capturing the medical event in the context of an insurance claim where patient data is merged with insurance demographics in Patient List and automatically sent to Visit Details for setting up the patient appointment.

FIG. 11 shows an example of some of the information Patient List uses to initiate the patient visit prior to sending data to Visit Details. FIG. 11 is a detail view showing how Patient List configures the data-set required to create the appointment according to some embodiments described herein. Because Patient List is another view of Patient Administration, the content seen in FIG. 11. is the same as Patient Administration's save that the patient's Exam Date is added (via Visit Details) into the data-set prior to sending Patient List information to Visit Details. The data streams in Patient List include: Patient ID, Patient Name, Patient Tel, Copay, Exam Date, and Patient Insurance #, Group #Insurance ID, Attending Doctor ID and Referring Doctor, when applicable.

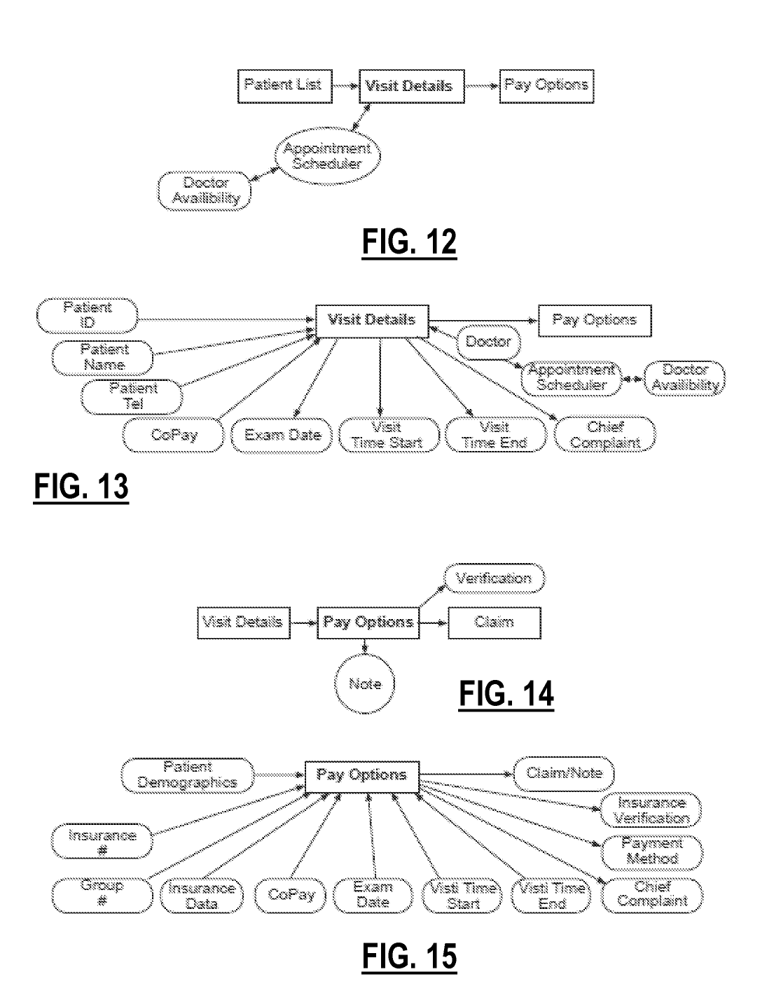

FIG. 12 depicts a visit details centric view (FIG. 1) of the system diagram where Visit Details gets content from Patient List and sends it to its appointment scheduler and doctor availability components for setting up patient visits before sending a subset of this content to Pay Options according to some embodiments described herein.

FIG. 13 shows an example of a work-flow of Visit Details and its link to Pay Options. In Visit Details, FIG. 13, an appointment scheduler combines the patient's exam date and visit time to doctor availability Note: In Patient List, the calendar from Visit Details shows what days, times and doctor(s) availability apply for the specific patient visit. FIG. 13 depicts the content used to build Visit Details including: Patient ID, Patient Name, Patient Tel, Copay, Exam Date, Visit Time Start, Visit Time End, Attending Doctor ID, Attending Doctor Name and the patient's Chief Complaint, the reason why the patient has set up the appointment to be examined. In some embodiments, once the Visit Details' information is keyed in, a subset of the data goes to Pay Options.

FIG. 14 displays a pay options centric view (FIG. 1) of the system work-flow diagram where Pay Options creates the integrated Claim/Note entity keyed to exam date after payment type has been established for the patient to pay for the visit and/or copay as needs warrant according to some embodiments described herein. FIG. 14 shows an example of how Pay Options may receive content from Visit Details prior to creating the integrated Claim/Note entity along with a Verification request, A, ANSI 270, sent to the patient's insurance company via the Export/Import Module to determine whether a patient is insured or not.

FIG. 15 illustrates an example of a Pay Options work-flow. FIG. 15 illustrates the Pay Options work-flow where Pay Options brings in, for example, Patient Demographics, Insurance number, Group number, Insurance Demographics, Copay, Exam Date, Visit Time Start, Visit Time End and Chief Complaint from Visit Details and integrates it with Payment Method and the Insurance Verification request to create the integrated Claim/Note entity. When Pay Options generates the integrated Claim/Note entity, its unique alphanumeric claim number, created in conjunction with Patient ID, Exam Date, Insurance number and Group number, becomes an identifying element the claim-driven medical event system uses to manage all aspects of the integrated claim-driven medical event.

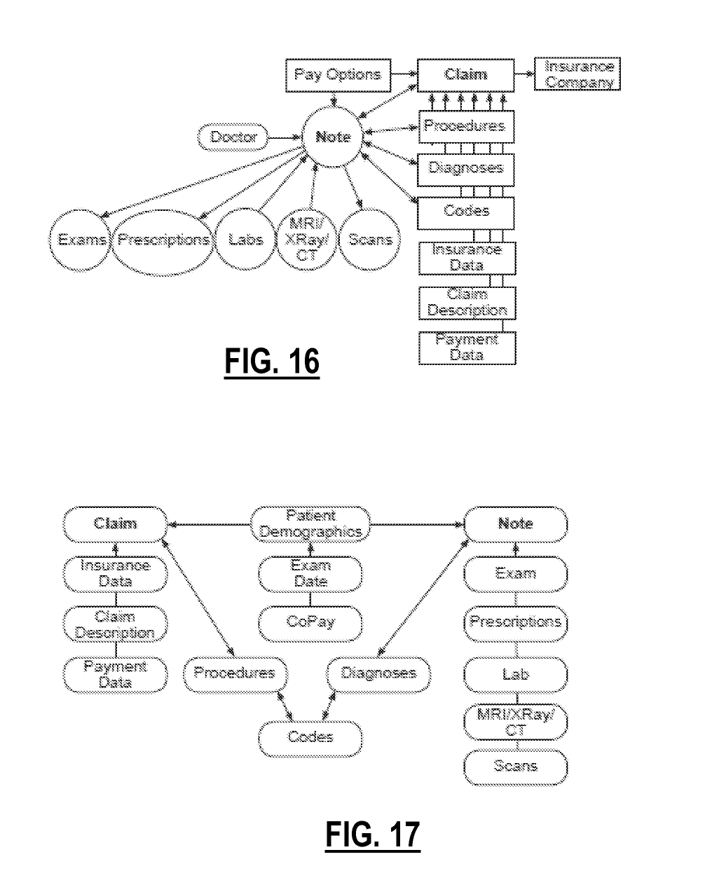

FIG. 16 shows the integrated claim/note centric view (FIG. 1) of the system work flow illustrating how the claim/note entity works as an integrated environment within the embodiment of the claim-driven medical event system according to some embodiments described herein. FIG. 16 shows the primary elements of the integrated Claim/Note entity created by Pay Options. As seen in the diagram, in this example, the Claim/Note entity uses Procedures, Diagnoses and related Codes, in part, to generate the following linked data-sets of the Claim/Note entity: On the Claim side—Insurance Data, Claim Description and Payment Data, in conjunction with Procedures, Diagnoses and Codes data-sets, goes to the insurance company, via ANSI 837, to be processed AFTER the doctor, via the Note side, populates the integrated Claim/Note entity by specifying the Procedure/Diagnoses/Code set keyed to patient treatment identified by the patient's unique alphanumeric Claim/Note # using the Exam as the start point and following up with a Prescription, Lab and/or MRI/X-ray/CTs,/Scan services, when appropriate.

FIG. 17 shows a different view of the Claim-Driven Medical Event depicting how the Integrated Claim/Note entity is populated by Patient Demographics, Exam Date and Copay data in addition to content from Procedures and Diagnoses according to some embodiments described herein. FIG. 17 shows an embodiment wherein the same Claim-Driven Medical Event where Patient Demographics, Exam Date and Copay populate both components of the integrated Claim/Note entity in similar fashion to Procedures, Diagnoses and Codes.

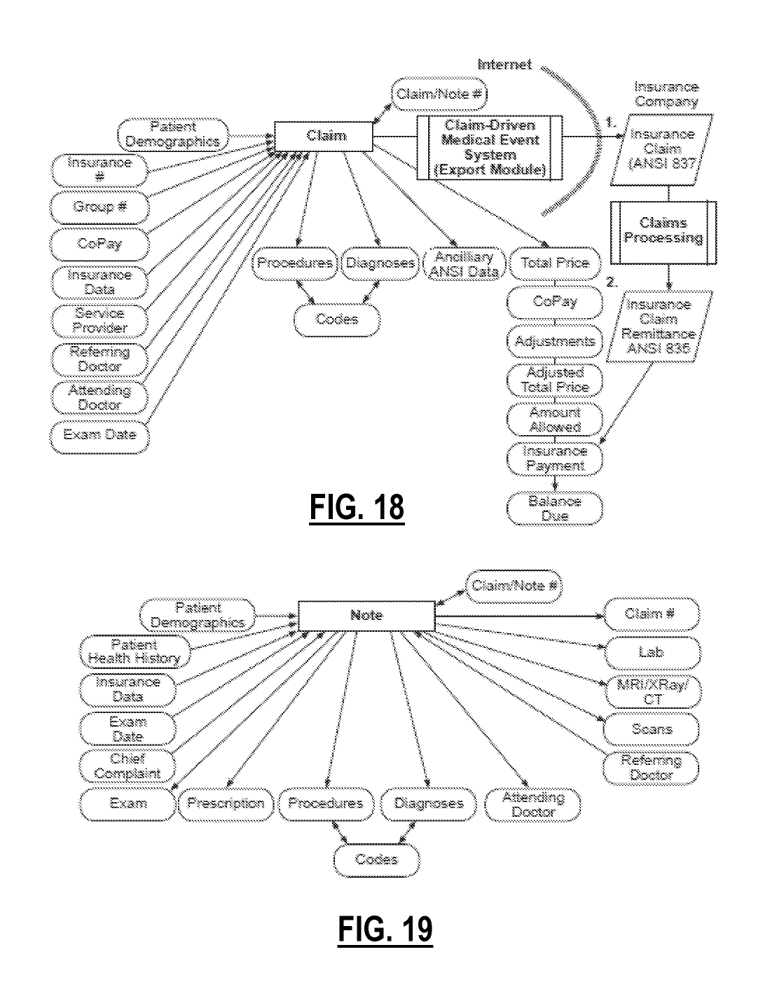

FIG. 18 displays an example of the Claim component of the integrated Claim/Note entity. In this example, all fields in the claim-driven medical event system 10 use the ANSI specification. In this example, the note is the initial driver of the claim as the doctor must specify procedure and diagnostic data before any claim can be sent to the insurance company to be processed. FIG. 18 displays an example of a Claim element of the integrated Claim/Note entity depicting incoming content consisting of: Patient Demographics, Insurance number, Group number, Copay, Insurance Data, Service Provider, Referring Doctor—when applicable, Attending Doctor and Exam Date. Claim-driven outgoing content may include: The Claim/Note number, Procedures, Diagnoses, Codes, Ancillary ANSI data (part of the complete ANSI 837 code set describing claim specifics as expressed in the integrated Claim/Note entity), Total Price, Copay, Adjustments, Adjusted Total Price, Amount Allowed, Insurance Payment and Balance Due. When applicable, the insurance claim, ANSI 837, is produced and exported via the system Export/Import Module to be processed. 1. The insurance company, in turn, sends an ANSI 835 file back to the claim-driven medical event system by the Export/Import Module 2. that matches the Claim number of the previously sent ANSI 837 insurance claim partner before relevant field content is extracted from the ANSI 835 file and placed into the proper field set of the previously submitted 837 insurance claim, thus enabling the embodiment of the claim-driven medical event system to automatically update any profit and loss statement keyed to any medical event-linked patient claim identified by its unique alphanumeric claim number,

FIG. 19 shows an example of the Note component of the integrated Claim/Note entity. FIG. 19 shows an example of a Note element of the integrated Claim/Note entity depicting the incoming information data-set consisting essentially of: Patient Demographics, Patient Health History, Insurance Data, Exam Date, Chief Complaint and outgoing Note content including Claim/Note number, Exam, Prescription, Procedures, Diagnoses, Codes, Attending Doctor, Referring Doctor—when applicable, Scans, and submissions for MRI/X-ray/CT and Lab services, when appropriate.

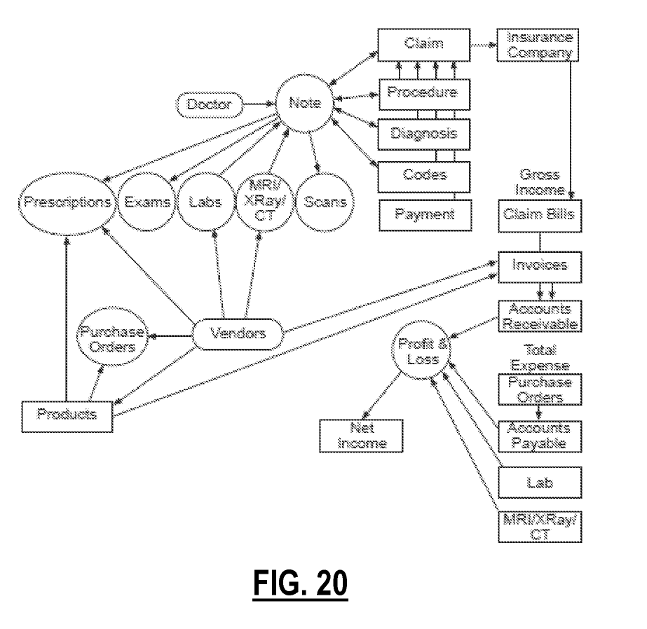

FIG. 20 shows an example of a Profit & Loss centric view (FIG. 1) of the system work-flow diagram showing how the Profit & Loss environment works in the claim-driven medical event system according to some embodiments described herein. FIG. 20 shows an example of how the Profit & Loss calculation engine works with the claim-driven medical event system 10 starting with Vendors sending demographic data to products, Prescriptions, Purchase Orders, Lab, MRI/XRay/CT, Claim Bill and Invoices and Products sending demographics and pricing to Purchase Orders, Prescriptions—when applicable, and Invoices. Because all of these entities are linked to the unique alphanumeric claim number of the patient claim-driven medical event, the claim-driven medical event system 10 can perform profit & loss calculations on patient claims by subtracting the total expense of Accounts Payable, Lab and MRI/X-ray/CT costs from the gross income of Accounts Receivable (Claim Bill and Invoices) to arrive at Net Income. Note: Lab and MRI/X-ray/CT services are rarely considered expenses in healthcare. Note II: The Claim Bill is another view of the integrated Claim/Note entity.

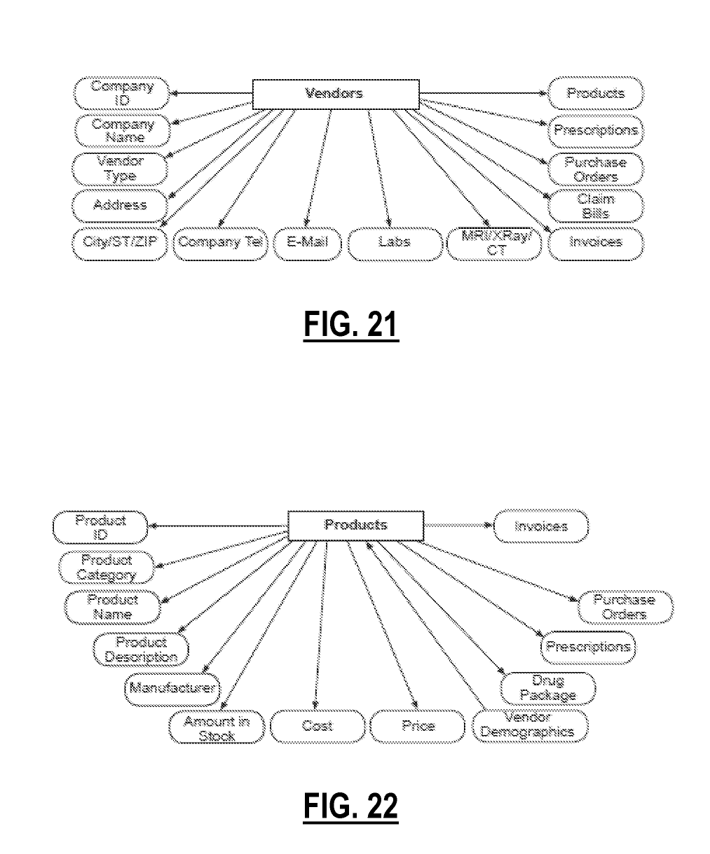

FIG. 21 depicts the work-flow of Vendors according to some embodiments described herein. FIG. 21 depicts an example of a Vendor element of the claim-driven medical event system supplying its demographic data of Company ID, Company Name, Vendor Type, Address, City/State/Zip, Company Tel & E-mail, when appropriate, to Products, Prescriptions, Purchase Orders, Claim Bills, Invoices, MRI/X-ray/CTs and Labs.

FIG. 22 illustrates the work-flow of Products according to some embodiments described herein. The Product data-set may include Product ID, Product Name, Product Description, Manufacturer, Amount in Stock, Cost and Price. Products sends this content, identified by Category, to Drug Package, Prescriptions, Purchase Orders and Invoices. Incoming content to Products consists of Vendor Demographics. Because Products is linked to Drug Packages via category, the claim-driven medical event system may automatically link the appropriate drug to its associated Drug Package via category when importing the Drugs@FDA Data File data-set.

The flexibility of Product Category, within the claim-driven medical event system 10, is advantageous as Product Categories enable the system to expand the notion of “Product” to apply to operating costs like Utilities, Office Supplies and Taxes in enabling the system to conduct accurate profit & loss calculations keyed to any medical event-linked patient claim identified by its unique alphanumeric claim number.

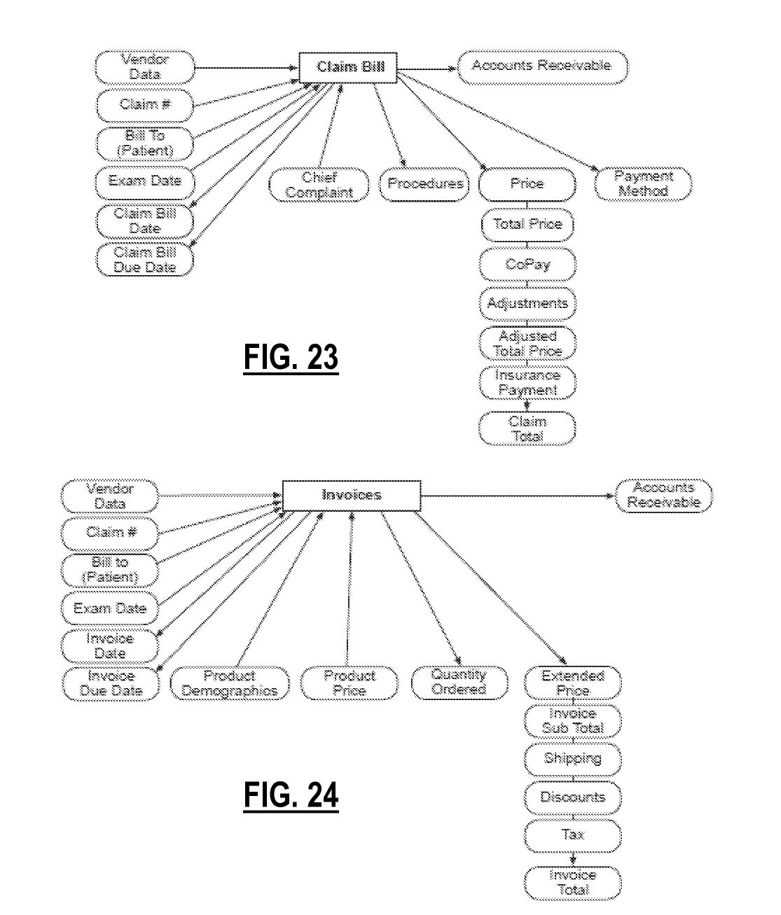

FIG. 23 displays an example of a Claim Bill, a component of the Integrated Claim/Note entity that resides in the claim-driven medical event system 10 according to some embodiments described herein. FIG. 23 displays an example of a Claim Bill, the third view of the Integrated Claim/Note entity. Incoming content may include Vendor Data, Claim number, Bill to (Patient), Exam Date and Chief Complaint and outgoing content consisting of: Claim Bill Date, Claim Bill Due Date, Procedures, Price, Total Price, Copay, Adjustments, Adjusted Total Price, Insurance Payment, and Claim Total. Payment method is included to facilitate payment of the bill either on or off line as needs warrant. The Claim Total goes to Accounts Receivable as representing the first part of the gross income component of profit and loss for the embodiment of the claim-driven medical event system 10.

FIG. 24 depicts an example of the Invoices work-flow, a component of the gross income component of the claim-driven medical event system. Note: Invoice may contain revenues outside the province of the claim. Invoices, the second income element of the claim-driven medical event system 10 according to some embodiments described herein, includes the same incoming content of Vendor Data, Claim number, Bill To (Patient), Exam Date along with Product Content consisting of Product Demographics and Product Price. Invoice outgoing data may include: Quantity Ordered, Extended Price, Invoice Sub Total, Shipping, Discounts, Tax and Invoice Total. Invoices cover billable products and services that reside outside the realm of Claim Bills, the first income element of the claim-driven medical event system. Invoices Total goes to Account Receivable.

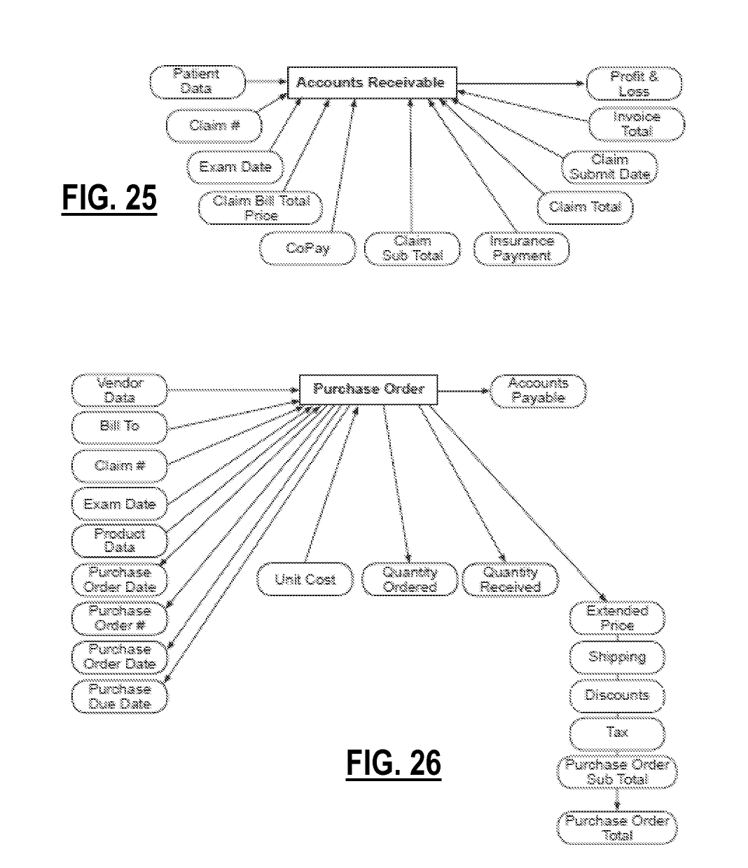

FIG. 25 depicts an example of an Accounts Receivable work-flow, the system element that imports information from the claim bill and invoice to generate the gross income part of the profit and loss entity user by the embodiment of the claim-driven medical event system according to some embodiments described herein. Accounts Receivable imports, for example, Patent Data, Claim number and Exam Date and links it to the Claim Bill Total Price, Copay, Claim Sub Total, Insurance Payment, Claim Total and Claim Submit Date. From Invoices, the Invoice Total is brought into Accounts Receivable and added to the Claim Total to generate the Gross Income of the medical event-linked patient claim identified by its unique alphanumeric number. Note that the Claim number may be preferably used by the claim-driven medical event system 10 in unifying the Clam Bill and the Invoice as the Gross Income component of the claim-driven medical event system 10. Claim Total and Invoice Total goes to Profit & Loss as the two income elements of the claim-driven medical event system 10.

FIG. 26 displays an example of a Purchase Order work-flow expense component of the claim-driven medical event system 10 according to some embodiments described herein. Purchase Orders FIG. 26, is the first expense component of the claim-driven medical event system according to some embodiments described herein. Incoming content consists of, for example, Vendor Data, Bill To Note: Bill To extends beyond just Patients in the claim-driven medical event system. Claim number Exam Date, Product Data, Price, Outgoing content consists of Purchase Order number, Purchase Order Date, Purchase Order Due Date, Quantity Ordered, Quantity Received, Extended Price, Shipping, Discounts, Tax, Purchase Order Sub Total and Purchase Order Total. Purchase Order Total plus Purchase Order demographic content may go to Accounts Payable.

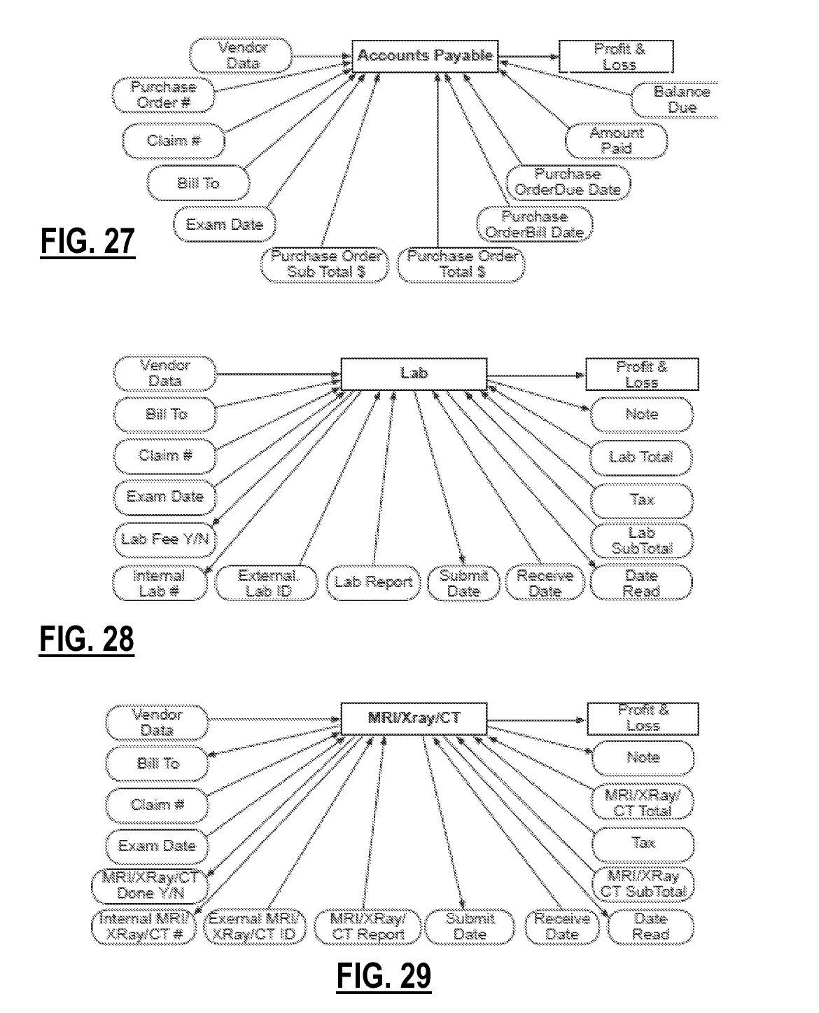

FIG. 27 shows an example of an Accounts Payable work-flow, the system entity that brings in data from the purchase order according to some embodiments described herein. Note: Accounts Payable, in some examples, works in similar fashion to Accounts Receivable in the embodiment of the claim-driven medical event system. Accounts Payable imports Purchase Order information, which may include: Vendor Data, Purchase Order number, Claim number, Bill To, Exam Date, Purchase Order Sub Total. Purchase Order Total, Purchase Order Bill Date, Purchase Order Due Date, Amount Paid and Balance Due. Accounts Payable may send the Purchase Order Total to the expense part of Profit & Loss.

FIG. 28 shows an example of a Lab work-flow according to some embodiments described herein. Note: Lab costs are rarely considered an expense in healthcare. Lab may import, for example, Vendor Data, Bill To, Claim number, Exam Date, External Lab ID, Lab Report, Receive Date, Lab Sub Total, Tax and Lab Total. Lab outgoing content includes Internal Lab number, Submit Date, Date Read and a link to the Note. The Lab Total goes to the expense part of Profit & Loss. Note. Lab fees are rarely considered expenses in healthcare.

FIG. 29 depicts an example of a MRI/X-ray/CT work-flow according to some embodiments described herein. Note: MRI/X-ray/CT costs are rarely considered an expense in healthcare. MRI/X-ray/CT may import, for example, Vendor Data, Bill To, Claim number, Exam Date, External MRI/X-ray/CT ID, MRI/X-ray/CT Report, Receive Date, MRI/X-ray/CT Sub Total, Tax and MRI/X-ray/CT Total. Outgoing content includes Internal MRI/X-ray/CT number, Submit Date, Date Read and a link to the Note. The MRI/X-ray/CT Total goes to the expense part of Profit & Loss.

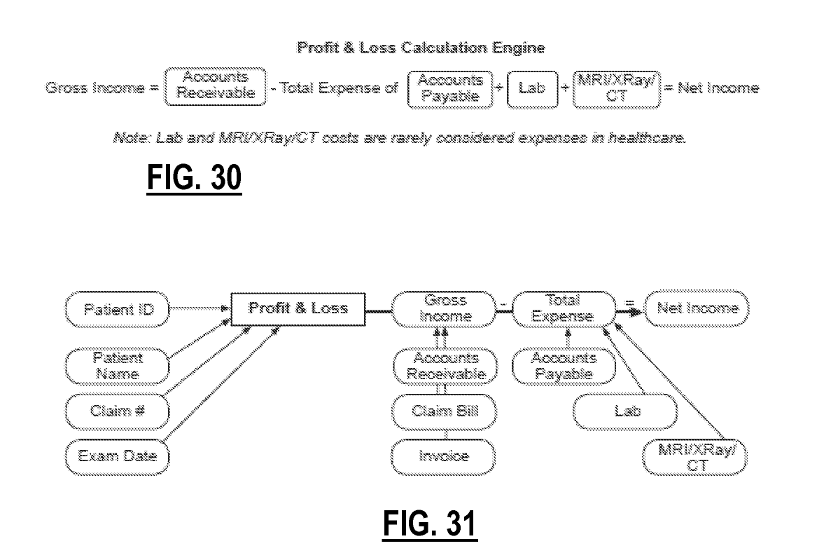

FIG. 30 shows an example of a claim-driven medical event system 10 Profit & Loss calculation engine. In some embodiments, the claim-driven medical event system 10, Profit & Loss calculation engine may be configured to calculate Net Income by first determining: Gross Income=as Accounts Receivable−Total Expense=Accounts Payable+Lab+MRI/X-ray/CT=Net Income. Note, as stated before, Lab and MRI/X-ray/CT fees are rarely considered expenses in healthcare.

FIG. 31 shows an example of a detail view of a Profit and Loss calculation engine work flow. FIG. 31 shows an example of one embodiment wherein the Profit and Loss calculation engine component of the claim-driven medical event system 10 connecting the medical event-linked patient claim data of Patient ID, Patient Name, Claim #, and Exam Date to its calculated Net Income statement arrived at by subtracting the Total Expense of Accounts Payable, Lab and MRI/X-ray/CT costs from the Gross Income of Accounts Receivable (Claim Bill+Invoice) Note: As stated before, Lab and MRI/X-ray/CT costs are rarely considered expenses in healthcare.

When creating the Vendor/Product data-set for the claim-driven medical event system 10, a prudent way to begin is keying in Product data first, followed by the Vendors who handle the product. Once this is done, it matters not whether the element that uses the Product Vendor data-set for the claim-driven medical event system be a Purchase Order, Invoice or to a Prescription, if applicable, when using the Product/Vendor data-set. FIG. 21, 22. Note: Multiple vendors can be assigned to a given product as more than one vendor often sells the same product to any organization.

In some embodiments, the system begins by using the complete ANSI 270/271/837/835 code set, or other suitable code set, FIG. 2 as the start point for naming the fields needed to generate the medical event in the context of an insurance claim. In the ANSI 837 specification, for example, patient ID equates to B26_PAN while last name equates to B2_LAST and First Name to B2_FIRST. By naming fields as per the standard ANSI 270/271/837/835 specification, the ability to develop the proper ANSI 270/271/837/835 export formats needed (XML JSON, XML, ANSI and Pipe Delimited Text to successfully work with insurance companies, is greatly facilitated, something the claim-driven medical event system does without issue.

In some embodiments, the claim-driven medical event system 10 includes a database wherein the database uses a traditional set of related tables to manage the different skeins of data needed to generate the integrated claim-driven Medical Event. Tables created in one embodiment of the system include the following: Claim, Lineltems, Patient, PayOptions, Insurance, InsuranceJoin, Case, Doctors, ReferringDoctors, Products, Vendors, Prescriptions, Invoices, PurchaseOrders, Accounts Payable, AccountsReceivable, Lab, MRI/XRay/CT, Scans, Exams and ProfitLoss. Note: Tables can be named differently as needs warrant.

In some embodiments of the claim-driven medical event system 10, the integrated Claim/Note entity also presents the Claim Bill, used as the first income stream by the Profit & Loss calculation engine for the system.

The claim-driven medical event system 10 is extremely flexible in terms of how data can be keyed in and processed as the claim-driven medical event system 10, as seen in this detailed description of the environment, is configured, from the onset, to generate the medical event in the context of the insurance claim, using, in large part, the integrated claim/note entity, thus enabling organizations to create and manage this kind information much more efficiently than is possible using existing technologies that keep the medical event separate from its insurance claim. In effect, the claim-driven medical event system, as described in this document, eliminates isolated “silos” of information currently compromising how the healthcare industry does business in today's complex and competitive marketplace.

In conclusion, another key concept in the development of this approach is that the system can output to any format one builds a filter for because it is based on, in some embodiments, an ANSI-compliant schema able to handle any file type as needs warrant.

The following are incorporated by reference herein: ANSI—American Standards Institute (www.ansi.org), JSON—JavaScript Object Notation (www.json.org), XML—Extensible Markup Language (www.xml.com), ASCII—American Standard Code for Information Interchange (www.ascii-code.com, www.w3schools.com/tags/ref_ascii.asp), Pipe Delimited Text (en.wikipedia.org/wiki), W3 Standards—(www.w3.org/standards), Common File Format Types (www.fileinfo.com/filetypes/common), and Open source file formats (en.wikipedia.org/wiki/Open_format).

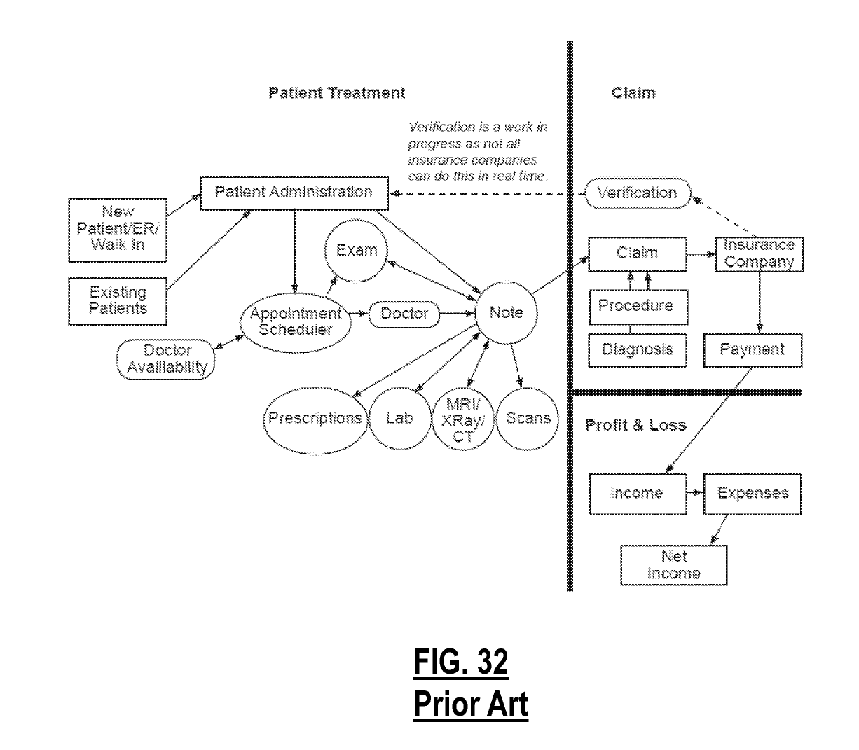

FIG. 32 is a work-flow diagram of conventional medical event processing with the claim aspects down on the backend. Conventionally, healthcare has serious problems one of which is the work-flow from an information technology (IT) perspective does not coincide with how a medical organization does business. FIG. 32 is a representation of practically every medical entity. The patient treatment aspects are sound, but the IT work-flow breaks down. Patient treatment works because it is in concert with how a practice does business. Claims and P&L are done separately resulting in siloed content unable to be searched, processed, or analyzed. The cost of managing these separate skeins of data is enormous.

There are various aspects of the conventional medical event processing that the claim driven medical event system seeks to improve. First, because the claim, the income stream, is conventionally done after the medical event has occurred, the ability to record the medical event with associated treatment/billing options in context cannot be done to any degree of efficiency. Second, the ability for patients to access their records in context is difficult at best because the data sets in question cannot be keyed to the specific medical event due to the existing workflow used by the medical practice. Third, P&L linked to a patient, range of dates, etc. using expenses and income is not possible because the claim is not properly integrated to the medical event. Fourth, the ability to manage, distribute, and search the data set is inefficient because the information is siloed thus eliminating the ability to leverage this content in any meaningful way. Fifth, because IT does not work in concert how the medical practice operates, there are logistical and financial issues. Sixth, PMS (Practice Management Software), billing apps, and hospital management programs are closed, proprietary systems and P&L calculations are not done in PMS environments. Seventh, insurance companies create complexity by making the claims process as complex as possible (which is a primary driver for keeping billing separate from PMS) and insurance has a process designed to pay the least amount possible.

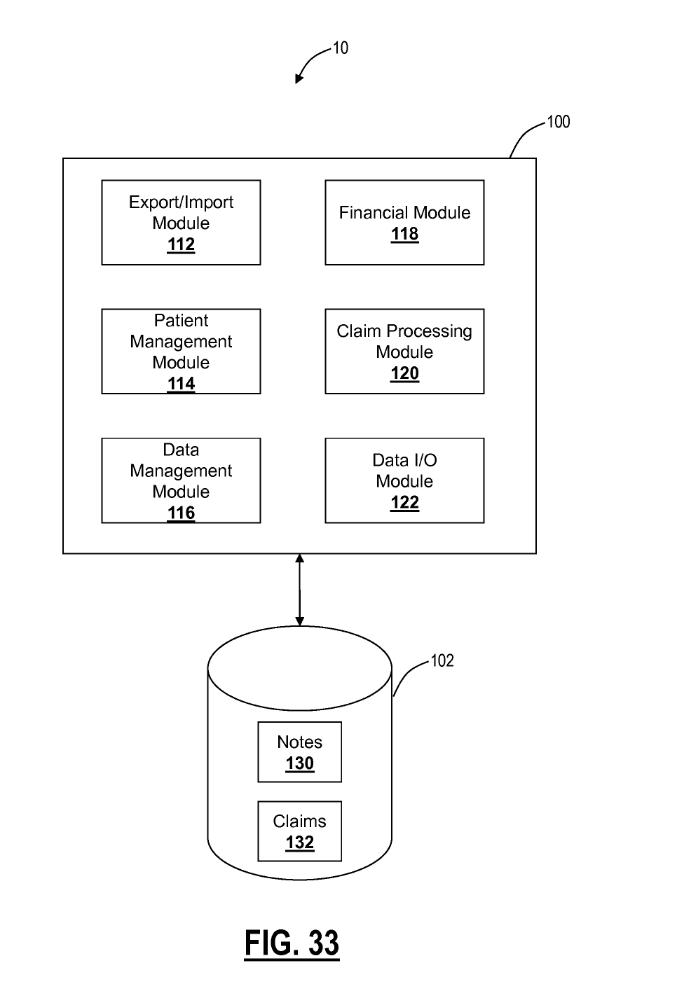

FIG. 33 is block diagram of an exemplary implementation of a claim-driven medical event system 10. The claim-driven medical event system 10 generally includes at least a computing platform 100 and a database 102. Note, the computing platform 100 and the database 102 can be implemented in a same server or group of servers. The various functionality described herein in FIGS. 1-31 can be implemented by various modules 112-122 in the claim-driven medical event system 10. Specifically, the claim-driven medical event system 10 can include an export/import module 112, a patient management module 114, a data management module 116, a financial module 118, a claim processing module 120, and a data input/output (I/O) module 122. The database 102 (again, this can be implemented in memory or a data store of the computing platform 100 or externally) includes notes 130 and claims 132. In an exemplary embodiment, each of the modules 112-122 are software instructions executed by the computing platform 100 to provide the functionality described herein.

The export/import module 112 performs the various export and import functions described herein. Again, the export/import module 112 uses, in some embodiments, the American National Standards Group (ANSI) Accredited Standards Committee (ASC) X12N 270, 271, 276, 277, 278, 820, 834, 835 and 837 Healthcare Administrative Transactions specifications dataset, in part, to convert output generated by the claim-driven medical event system into four open source file formats including but not limited to: JSON (Javascript Object Notation), XML, ANSI and ASCII pipe-delimited text able to 1. export ANSI 270 (Insurance Eligibility Verification Request) for patient eligibility verification and ANSI 837 (Insurance Claim) for processing claims to insurance companies and 2. import ANSI 271 (Insurance Eligibility Verification Response) to determine whether a patient is insured and ANSI 835 (Insurance Claim Response Remittance) receiving payment for services rendered from insurance companies on an as needs basis. Other formats are also contemplated. From the export/import module 112, the claim-driven medical event system 10 can interact with other systems such as but not limited to PMS, insurance companies, accounting, etc. The export/import module 112 can perform the functionality described in FIGS. 1, 3-4, 5-7, etc.

The patient management module 114 is used to manage patient related data—contact info, health history, appointments, insurance and payment info, etc. For example, the patient management module 114 can perform the functionality described in FIGS. 1, 5-7, 9-15, etc. The data management module 116 is configured to manage the data in the database 102, i.e. the notes 130, 132. The financial module 118 is configured to perform financial-related matters such as calculating P&L as described, for example, in FIGS. 21-31. The claim processing module 120 is configured to take the notes 130 and create correlated claims 132 such as described in FIGS. 16-20. Finally, the data I/O module 122 includes a graphical user interface (GUI) to allow user interaction with the claim-driven medical event system 10. This can include a web-based interface, an “app” for a tablet or smartphone, a native desktop application, or a combination thereof.

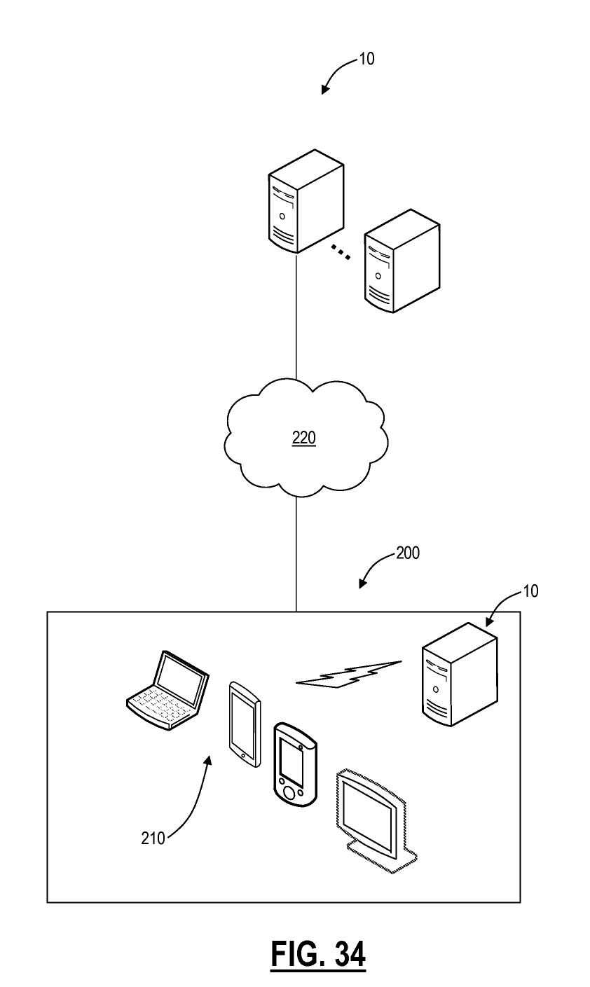

FIG. 34 is a network diagram of a medical practice 200 using the claim-driven medical event system 10. The medical practice 200 can be a physician's office, a hospital, an urgent care, etc. Within the medical practice 200, there are various users 210 who can interface the claim-driven medical event system 10 in a technology agnostic fashion, i.e. the users 210 can use laptops, desktops, smart phones, tablets, net books, ultra books, etc. The users 210 can include without limitation doctors, nurses, physician assistants, secretaries, appointment schedulers, etc. In an exemplary embodiment, the claim-driven medical event system 10 can be locally hosted by the medical practice 200. In another exemplary embodiment, the claim-driven medical event system 10 can be remotely hosted, i.e. in the cloud, and connected to the medical practice 200 by a network 220 such as the Internet. Here, data transmissions can use secure tunneling or the like to preserve confidentiality.

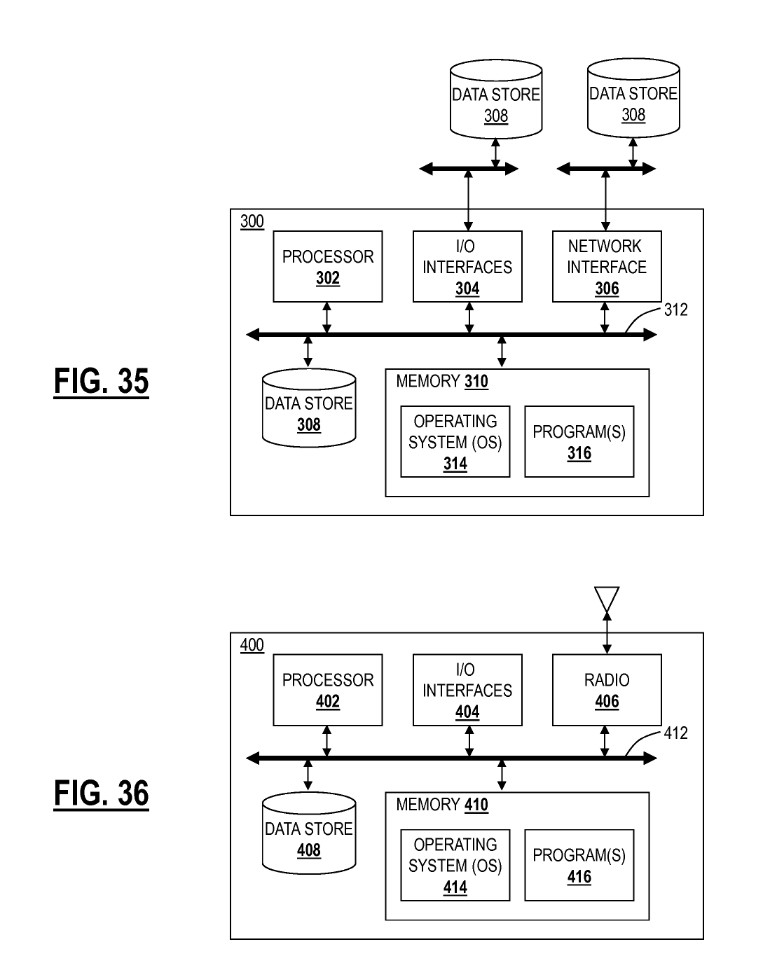

FIG. 35 is a block diagram of a server 300 which may be used in the claim-driven medical event system 10, for the computing platform 100, in other systems, or standalone. The server 300 may be a digital computer that, in terms of hardware architecture, generally includes a processor 302, input/output (I/O) interfaces 304, a network interface 306, a data store 308, and memory 310. It should be appreciated by those of ordinary skill in the art that FIG. 35 depicts the server 300 in an oversimplified manner, and a practical embodiment may include additional components and suitably configured processing logic to support known or conventional operating features that are not described in detail herein. The components (302, 304, 306, 308, and 310) are communicatively coupled via a local interface 312. The local interface 312 may be, for example but not limited to, one or more buses or other wired or wireless connections, as is known in the art. The local interface 312 may have additional elements, which are omitted for simplicity, such as controllers, buffers (caches), drivers, repeaters, and receivers, among many others, to enable communications. Further, the local interface 312 may include address, control, and/or data connections to enable appropriate communications among the aforementioned components.

The processor 302 is a hardware device for executing software instructions. The processor 302 may be any custom made or commercially available processor, a central processing unit (CPU), an auxiliary processor among several processors associated with the server 300, a semiconductor-based microprocessor (in the form of a microchip or chip set), or generally any device for executing software instructions. When the server 300 is in operation, the processor 302 is configured to execute software stored within the memory 310, to communicate data to and from the memory 310, and to generally control operations of the server 300 pursuant to the software instructions. The I/O interfaces 304 may be used to receive user input from and/or for providing system output to one or more devices or components. User input may be provided via, for example, a keyboard, touch pad, and/or a mouse. System output may be provided via a display device and a printer (not shown). I/O interfaces 304 may include, for example, a serial port, a parallel port, a small computer system interface (SCSI), a serial ATA (SATA), a fibre channel, Infiniband, iSCSI, a PCI Express interface (PCI-x), an infrared (IR) interface, a radio frequency (RF) interface, and/or a universal serial bus (USB) interface.

The network interface 306 may be used to enable the server 300 to communicate on a network, such as the Internet, a wide area network (WAN), a local area network (LAN), and the like, etc. The network interface 306 may include, for example, an Ethernet card or adapter (e.g., 10BaseT, Fast Ethernet, Gigabit Ethernet, 10 GbE) or a wireless local area network (WLAN) card or adapter (e.g., 802.11a/b/g/n). The network interface 306 may include address, control, and/or data connections to enable appropriate communications on the network. A data store 308 may be used to store data, such as the database 102. The data store 308 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 308 may incorporate electronic, magnetic, optical, and/or other types of storage media. In one example, the data store 308 may be located internal to the server 300 such as, for example, an internal hard drive connected to the local interface 312 in the server 300. Additionally in another embodiment, the data store 308 may be located external to the server 300 such as, for example, an external hard drive connected to the I/O interfaces 304 (e.g., SCSI or USB connection). In a further embodiment, the data store 308 may be connected to the server 300 through a network, such as, for example, a network attached file server.

The memory 310 may include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 310 may incorporate electronic, magnetic, optical, and/or other types of storage media. Note that the memory 310 may have a distributed architecture, where various components are situated remotely from one another, but can be accessed by the processor 302. The software in memory 310 may include one or more software programs, each of which includes an ordered listing of executable instructions for implementing logical functions. The software in the memory 310 includes a suitable operating system (O/S) 314 and one or more programs 316. The operating system 314 essentially controls the execution of other computer programs, such as the one or more programs 316, and provides scheduling, input-output control, file and data management, memory management, and communication control and related services. The one or more programs 316 may be configured to implement the various processes, algorithms, methods, techniques, etc. described herein.

Referring to FIG. 36, in an exemplary embodiment, a block diagram illustrates a mobile device 400, which may be used to access the claim-driven medical event system 10 or the like. The mobile device 400 can be a digital device that, in terms of hardware architecture, generally includes a processor 402, input/output (I/O) interfaces 404, a radio 406, a data store 408, and memory 410. It should be appreciated by those of ordinary skill in the art that FIG. 36 depicts the mobile device 400 in an oversimplified manner, and a practical embodiment may include additional components and suitably configured processing logic to support known or conventional operating features that are not described in detail herein. The components (402, 404, 406, 408, and 402) are communicatively coupled via a local interface 412. The local interface 412 can be, for example but not limited to, one or more buses or other wired or wireless connections, as is known in the art. The local interface 412 can have additional elements, which are omitted for simplicity, such as controllers, buffers (caches), drivers, repeaters, and receivers, among many others, to enable communications. Further, the local interface 412 may include address, control, and/or data connections to enable appropriate communications among the aforementioned components.

The processor 402 is a hardware device for executing software instructions. The processor 402 can be any custom made or commercially available processor, a central processing unit (CPU), an auxiliary processor among several processors associated with the mobile device 400, a semiconductor-based microprocessor (in the form of a microchip or chip set), or generally any device for executing software instructions. When the mobile device 400 is in operation, the processor 402 is configured to execute software stored within the memory 410, to communicate data to and from the memory 410, and to generally control operations of the mobile device 400 pursuant to the software instructions. In an exemplary embodiment, the processor 402 may include a mobile optimized processor such as optimized for power consumption and mobile applications. The I/O interfaces 404 can be used to receive user input from and/or for providing system output. User input can be provided via, for example, a keypad, a touch screen, a scroll ball, a scroll bar, buttons, bar code scanner, and the like. System output can be provided via a display device such as a liquid crystal display (LCD), touch screen, and the like. The I/O interfaces 404 can also include, for example, a serial port, a parallel port, a small computer system interface (SCSI), an infrared (IR) interface, a radio frequency (RF) interface, a universal serial bus (USB) interface, and the like. The I/O interfaces 404 can include a graphical user interface (GUI) that enables a user to interact with the mobile device 400. Additionally, the I/O interfaces 404 may further include an imaging device, i.e. camera, video camera, etc.

The radio 406 enables wireless communication to an external access device or network. Any number of suitable wireless data communication protocols, techniques, or methodologies can be supported by the radio 406, including, without limitation: RF; IrDA (infrared); Bluetooth; ZigBee (and other variants of the IEEE 802.15 protocol); IEEE 802.11 (any variation); IEEE 802.16 (WiMAX or any other variation); Direct Sequence Spread Spectrum; Frequency Hopping Spread Spectrum; Long Term Evolution (LTE); cellular/wireless/cordless telecommunication protocols (e.g. 3G/4G, etc.); wireless home network communication protocols; paging network protocols; magnetic induction; satellite data communication protocols; wireless hospital or health care facility network protocols such as those operating in the WMTS bands; GPRS; proprietary wireless data communication protocols such as variants of Wireless USB; and any other protocols for wireless communication. The data store 408 may be used to store data. The data store 408 may include any of volatile memory elements (e.g., random access memory (RAM, such as DRAM, SRAM, SDRAM, and the like)), nonvolatile memory elements (e.g., ROM, hard drive, tape, CDROM, and the like), and combinations thereof. Moreover, the data store 408 may incorporate electronic, magnetic, optical, and/or other types of storage media.

The memory 410 may include any of volatile memory elements (e.g., random access memory (RAM, such as DRAM, SRAM, SDRAM, etc.)), nonvolatile memory elements (e.g., ROM, hard drive, etc.), and combinations thereof. Moreover, the memory 410 may incorporate electronic, magnetic, optical, and/or other types of storage media. Note that the memory 410 may have a distributed architecture, where various components are situated remotely from one another, but can be accessed by the processor 402. The software in memory 410 can include one or more software programs, each of which includes an ordered listing of executable instructions for implementing logical functions. In the example of FIG. 36, the software in the memory 410 includes a suitable operating system (O/S) 414 and programs 416. The operating system 414 essentially controls the execution of other computer programs, and provides scheduling, input-output control, file and data management, memory management, and communication control and related services. The programs 416 may include various applications, add-ons, etc. configured to provide end user functionality with the mobile device 400. For example, exemplary programs 416 may include, but not limited to, a web browser, social networking applications, streaming media applications, games, mapping and location applications, electronic mail applications, financial applications, and the like. In a typical example, the end user typically uses one or more of the programs 416 along with a network such as the system 10.

Variously, the claim-driven medical event system 10 provides a better way to do healthcare. The claim-driven medical event system 10 is an open source, healthcare system, linked to patient medical events, that changes how healthcare is done because, for the first time, all the data produced by any medical practice, can be created in context to the medical event, able to be processed, searched and distributed to all significant parties on an as needs basis, thus eliminating the enormous costs associated with the inherent siloing of data that currently plagues current healthcare practices. Additionally, because all the content generated by any given organization is now structured, the ability to leverage this content in innovative ways (AI, Predictive Analytics Research) extends far beyond the capabilities of today's closed and outdated healthcare environment.

The claim-driven medical event system 10 uses a different workflow approach that enables the integration of all the relevant information that goes into the creation of the medical event to include Patient Administration, Patient Chart, Note, Lab, Imaging, Prescriptions, Note-related documents and the Claim. The advantage of managing healthcare in this fashion is significant for the following reasons.

1. All the data is carried along, in context, with the medical event identified by Patient ID, Record ID and Exam Date, thus making the medical event a living document, able to be accessed and processed in ways that cannot be done by traditional means;
2. Patient insurance verification is easily done because the claim-driven medical event system 10 workflow permits this;
3. Accurate Profit & Loss (expense to date, income to date) via range of dates can be calculated in real time. Profit & Loss (keyed to individual patients) can be calculated in real time;
4. The claim-driven medical event system 10 is 837/1500 compliant, thus insuring accurate 837 claim submission to insurance companies.
5. Due to the claim-driven medical event system 10 workflow, the claim is accurately configured from the beginning, which means disputes between doctors and insurance companies become financial, not technical;
6. The claim-driven medical event system 10 also does 270/271 insurance verification and 835 remuneration due to the modular design set of the application;
7. Digital outside services (lab/image/financial) can easily link to claim-driven medical event system 10 as the file types they use are already web compliant as are claim-driven medical event system 10. File types include .pdf, .xls, .csv, .jpg, .txt .tab etc.;
8. Siloing of data goes away because the data set that comprises the medical event is now properly structured and able to be shared to relevant parties without issue, thus fundamentally changing how healthcare conducts business both on and off the web;
9. Patient records, in context, are automatically generated and placed online as a living entity, able to be accessed, downloaded and shared based on patient dictates. This is a one to one match to what the doctor creates when she is putting together the medical event via the note, which means doctors no longer have to think about getting patient records out in context because they already are due to claim-driven medical event system 10 unique workflow design set;
10. Costs go down enormously because billers can use the same program as doctors as the note is, in effect, the same thing as the claim with the claim dealing with financial while the note handles medical. The claim-driven medical event system 10 can also be used without insurance as well because the medical event id can act as the identifier for patient treatment records for doctors who don't take insurance;
11. Because ICD 10 is a world standard and has been used by other nations since 1995, (Procedures & Diagnosis codes) the notion of claim-driven medical event system 10 becoming an international open standard becomes logical because the 1500 process by which doctors bill and do medicine, is fundamentally sound;
12. Developing the claim-driven medical event system 10 as an open source environment available to all at no cost, enables the creation of an ecosystem for medical akin to Google Play, Apple App Store and Microsoft Store as the web already accommodates this kind of approach to software design without issue. Profit accrued will center on insurance verification, patient payment & claim transactions; and
13. Doctors, for the first time, can now practice medicine the way they want to because IT will now work in concert with how they do business, both on and off the web.

Initial estimates by several medium-sized medical practices in Connecticut have calculated that the claim-driven medical event system 10 could reduce operational expenses by as much as 30% per year. However, in light of the cost savings and strong earnings realized in other industries that have moved to a more connected business model in recent times, that figure may be prove to be conservative.

The claim-driven medical event system 10 can include a method for capturing a medical event (patient treatment keyed to exam date) in the context of an insurance claim including the creation of an integrated claim/note entity capable of producing medical event and note/claim related data within the system. The claim-driven medical event system 10 can include a method to export medical event information to any outside party, including insurance companies, able to accept & process said content in open source/common file formats including the use of JSON, ANSI, txt, .xls, .xlsx, .csv, .tab, .htm, .dbf, .xml, pdf and pipe delimited text.

The claim-driven medical event system 10 can include a method to import files from outside parties including the ability to use open source/common file formats including: JSON, ANSI, txt, .xls, .xlsx, .csv, .tab, .htm, .dbf, .xml, pdf and pipe delimited text. The claim-driven medical event system 10 can include a method to properly identify database fields pertinent to the creation of the claim-driven medical event including the use of the American National Standards Group (ANSI) Accredited Standards Committee (ASC) X12N 270, 271, 276, 277, 278, 820, 834, 835 and 837 Healthcare Administrative Transactions code E.g. Patient ID (B26_PAN), Patient First Name (B2_FIRST), Patient Last Name (B2_LAST).

The claim-driven medical event system 10 can include a method to generate Verification ANSI 270 requests including the use of the American National Standards Group (ANSI) Accredited Standards Committee (ASC) X12N 270, 271, 276, 277, 278, 820, 834, 835 and 837 Healthcare Administrative Transactions code set to identify fields pertinent to the creation of the insurance verification request document. E.g. Patient ID (B26_PAN), Patient First Name (B2_FIRST), Patient Last Name (B2_LAST). The claim-driven medical event system 10 can include. a method to link the verification ANSI 270 request to the same unique alphanumeric claim number of its related claim-driven medical event document including the use of the system's integrated claim/note entity.

The claim-driven medical event system 10 can include a method to export eligibility verification requests, ANSI 270 files using an Export/Import module. The claim-driven medical event system 10 can include a method to properly format insurance claim ANSI 837 files including the ability to use American National Standards Group (ANSI) Accredited Standards Committee (ASC) X12N 270, 271, 276, 277, 278, 820, 834, 835 and 837 Healthcare Administrative Transactions code set to identify fields pertinent to the creation of the insurance verification request document. E.g. Patient ID (B26_PAN), Patient First Name (B2_FIRST), Patient Last Name (B2_LAST).

The claim-driven medical event system 10 can include a method to link the insurance, claim, ANSI 837, to the same unique alphanumeric claim # of its related claim-driven medical event document including the use of the system's integrated claim/note entity. The claim-driven medical event system 10 can include a method to export ANSI 837 claims including the use of the system's export/import module. The claim-driven medical event system 10 can include a method to accept ANSI 835 insurance response remittances keyed to already submitted ANSI 837 insurance claims using an Export/Import module.

The claim-driven medical event system 10 can include a method to conduct profit and loss calculations on the medical event linked patient insurance claim identified by its unique alphanumeric claim number including the use of an additional entity data-set to identify database fields pertinent to calculating the gross income and total expense incurred in the medical event linked patient claim identified by its unique alphanumeric claim number and the use of calculation scripts keyed to the entity data-set required to perform the mathematical operations needed to arrive at the net income of a medical event-linked patient claim, identified by its unique alphanumeric claim number by subtracting gross expenses from gross income.

The claim-driven medical event system 10 can include a method to update the profit and loss statement of a medical event-linked patient claim identified by its unique alphanumeric claim number including the ability to import exported insurance company payment data in ANSI 835 to the embodiment of the claim-drive medical event system to be processed; the ability to match the claim number of the imported ANSI 835 insurance response text file to its already sent ANSI 837 claim partner before relevant field content is extracted from the ANSI 835 text file and placed into the proper field set of the previously submitted ANSI 837 insurance claim, thus enabling the embodiment of the claim-driven medical event system to automatically update any profit and loss statement keyed to any medical event/patient insurance claim identified by its unique alphanumeric claim number.

Again, the embodiment of the claim-driven medical event system is an event-driven software program able to capture the medical event (patient treatment keyed to exam date) in the context of an insurance claim using the American National Standards Group (ANSI) Accredited Standards Committee (ASC) X12N 270, 271, 276, 277, 278, 820, 834, 835 and 837 Healthcare Administrative Transactions specifications as its relational data persistence schema in conjunction with an additional script-driven data-set capable of conducting profit & loss calculations on the medical event-linked patient claim identified by its unique alphanumeric claim number

The embodiment of the claim-driven medical event system produces linked medical insurance verification request and claim files in ANSI 270/837 files able to be exported to insurance company system able to process this content for insurance verification and claim processing.

The embodiment of the claim-driven medical event system accepts medical insurance verification response and claim response remittance files in ANSI 271/835 used to verify patient eligibility and receive payment for services rendered.

The embodiment of the claim-driven medical event system produces the complete medical event (including its integrated verification request and claim content data-set identified by it's unique alphanumeric claim #) in open source/common file formats including: JSON, ANSI, txt, .xls, .xlsx, .csv, .tab, .htm, .dbf, .xml, pdf and pipe delimited text, able to be modified, searched and distributed to outside parties both on and off the web through the use of an integrated Claim/Note entity, created in conjunction with Patient ID, Exam Date, Insurance # and Group #.

The embodiment of the claim-driven medical event system also connects to any outside healthcare system able to process and share content using open source/common file formats including: JSON, ANSI, txt, .xls, .xlsx, .csv, .tab, .htm, .dbf, .xml, pdf and pipe delimited text.

The embodiment of the claim-driven medical event system eliminates isolated “silos” of information currently compromising the healthcare industry due to the fact the medical event and it's insurance claim, identified by its unique alphanumeric claim #, is an integrated data-set able to be processed in ways difficult to achieve using currently existing methodology

The embodiment of the claim-driven medical event system employs a design schema, as described in this document, able to be applied to any object/relational database and associated software stack as needs warrant.

In an exemplary embodiment, a method for processing a medical claim using computer implemented methods includes a. capturing a healthcare services event in the context of an insurance claim using the American National Standards Group (ANSI) Accredited Standards Committee (ASC) X12N 270, 271, 276, 277, 278, 820, 834, 835 and 837 Healthcare Administrative Transactions specifications; b. exporting and importing ANSI 270/271 (Eligibility Request/Eligibility Verification) files to and from insurance companies at the time the patient shows up for a visit, using an Export/Import module able to generate a variety of open source and common file formats including but not limited to JSON, ANSI, txt, .xls, .xlsx, .csv, .tab, .htm, .dbf, .xml, pdf and pipe delimited text; c. completing the Note component of the integrated claim/note entity to include the doctor supplied procedure & diagnostic content needed to create a valid insurance claim, ANSI 837, as all of the patient/insurance/copay and exam date data has already been generated when the patient set up the visit; d. exporting and importing ANSI 837/835 (Insurance Claim//Claim Remittance) files to and from insurance companies after the claim has been created, using an Export/Import module able to generate a variety of open source and common file formats including but not limited to JSON, ANSI, txt, .xls, .xlsx, .csv, .tab, .htm, .dbf, .xml, pdf and pipe delimited text; e. generating accurate profit and loss statements keyed to the patient's unique alphanumeric claim # due to the fact the claim/note data-set is fully integrated into the medical event schema along with operational components such as accounts receivable and accounts payable, entities able to be assessed against a variety of metrics including billing cycles, providers, tax periods and individual patient claims; f. exporting all medical event data to outside parties on an as needs basis using a variety of open source and common file formats including but not limited to JSON, ANSI, txt, .xls, .xlsx, .csv, .tab, .htm, .dbf, .xml, pdf and pipe delimited text; g. importing and sharing data with outside parties on an as needs basis using a variety of open source and common file formats including but not limited to JSON, ANSI, txt, .xls, .xlsx, .csv, .tab, .htm, .dbf, .xml, pdf and pipe delimited text; and h. eliminating isolated “silos” of information currently compromising how the healthcare industry does business in today's complex and competitive marketplace by implementing a claim-driven medical event systems approach able to integrate and share this data to all relevant parties in efficient fashion.

One exemplary advantage of the present disclosure is an ability to export the complete “ongoing” medical event data set of a patient or a given range of patients, dates, etc., including financial data, in real time, tailored to specific researcher needs, to determine, not only the efficacy of medical treatment keyed to a relevant physical condition but also to determine the actual cost of the treatment. This is a capability that, at best, is extremely difficult to achieve, if not impossible to do, using the exiting workflow as practiced by the healthcare industry today because, in part, of the siloing of information. Note, the elements of the medical event include Note (exam/procedures & diagnosis), Prescriptions (when applicable), Drug cost (when pricing is available), Lab (when applicable), Imaging, (when applicable), Insurance claim data (when applicable—ANSI 270/verification request, 271/Insurance verification, 837 insurance claim, ANSI 835 Insurance remuneration and Profit & Loss (when applicable), Account receivable-accounts payable, and the like. Plus, this can be done in an easily accessible web application via open source, etc.

It will be appreciated that some exemplary embodiments described herein may include one or more generic or specialized processors (“one or more processors”) such as microprocessors, digital signal processors, customized processors, and field programmable gate arrays (FPGAs) and unique stored program instructions (including both software and firmware) that control the one or more processors to implement, in conjunction with certain non-processor circuits, some, most, or all of the functions of the methods and/or systems described herein. Alternatively, some or all functions may be implemented by a state machine that has no stored program instructions, or in one or more application specific integrated circuits (ASICs), in which each function or some combinations of certain of the functions are implemented as custom logic. Of course, a combination of the aforementioned approaches may be used. Moreover, some exemplary embodiments may be implemented as a non-transitory computer-readable storage medium having computer readable code stored thereon for programming a computer, server, appliance, device, etc. each of which may include a processor to perform methods as described and claimed herein. Examples of such computer-readable storage mediums include, but are not limited to, a hard disk, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory), Flash memory, and the like. When stored in the non-transitory computer readable medium, software can include instructions executable by a processor that, in response to such execution, cause a processor or any other circuitry to perform a set of operations, steps, methods, processes, algorithms, etc.

Although the present disclosure has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present disclosure, are contemplated thereby, and are intended to be covered by the following claims.

What is claimed is:

1. A computer-implemented method, comprising:
receiving information for a healthcare services event for a patient and creating a note based therein;
performing an insurance Eligibility Request/Eligibility Verification by with an insurance company utilizing patient information converted into a format readable by the insurance company;
receiving information as the healthcare services event is performed to complete the note, wherein the note comprises doctor supplied procedure and diagnostic content needed to create a valid insurance claim; and
converting the note into an insurance claim and providing the insurance claim to the insurance company in a format readable by the insurance company;
wherein the note is setup to automatically convert to the insurance claim without back-end user input or coding.

2. The computer-implemented method of claim 1, further comprising:
tracking all activity related to the healthcare services event in the note, wherein the activity comprises doctor diagnosis, codes, procedures, prescriptions, exams, labs, and scans as well as third-party vendor activity; and
determining profit and loss related to the healthcare services event.

3. The computer-implemented method of claim 1, wherein the format readable by the insurance company comprises an open source format.

4. The computer-implemented method of claim 3, wherein the open source format comprises any of JSON, ANSI, txt, .xls, .xlsx, .csv, .tab, .htm, .dbf, .xml, pdf and pipe delimited text.

5. The computer-implemented method of claim 1, wherein the note captures the healthcare services event in context of an insurance claim using American National Standards Group (ANSI) Accredited Standards Committee (ASC) X12N 270, 271, 276, 277, 278, 820, 834, 835 and 837 Healthcare Administrative Transactions specifications.

6. The computer-implemented method of claim 1, further comprising:
performing the insurance Eligibility Request/Eligibility Verification by exporting and importing ANSI 270/271 (Eligibility Request/Eligibility Verification) files to and from the insurance company.

7. The computer-implemented method of claim 1, further comprising:
converting the note into an insurance claim and providing the insurance claim to the insurance company by exporting and importing ANSI 837/835 (Insurance claim//claim Remittance) files to and from the insurance company.

8. The computer-implemented method of claim 1, wherein the note records a complete healthcare services event including its associated verification request and claim information in open source/common file formats.

9. The computer-implemented method of claim 1, further comprising:
tracking costs and details related to labs, MRIs, X-Rays, and CT scans in the note.

10. The computer-implemented method of claim 1, wherein insurance related information is determined concurrently with preparation of the note thereby avoiding back-end processing and user coding.

11. A system, comprising:
a network interface, a data store, and a processor, each communicatively coupled therebetween; and
memory storing instructions that, when executed, cause the processor to:
receive information for a healthcare services event for a patient and creating a note based therein;
perform an insurance Eligibility Request/Eligibility Verification by with an insurance company utilizing patient information converted into a format readable by the insurance company;
receive information as the healthcare services event is performed to complete the note, wherein the note comprises doctor supplied procedure and diagnostic content needed to create a valid insurance claim; and
convert the note into an insurance claim and providing the insurance claim to the insurance company in a format readable by the insurance company;
wherein the note is setup to automatically convert to the insurance claim without back-end user input or coding.

12. The system of claim 11, wherein the instructions that, when executed, further cause the processor to:
track all activity related to the healthcare services event in the note, wherein the activity comprises doctor diagnosis, codes, procedures, prescriptions, exams, labs, and scans as well as third-party vendor activity; and
determine profit and loss related to the healthcare services event.

13. The system of claim 11, wherein the format readable by the insurance company comprises an open source format.

14. The system of claim 13, wherein the open source format comprises any of JSON, ANSI, txt, .xls, .xlsx, .csv, .tab, .htm, .dbf, .xml, pdf and pipe delimited text.

15. The system of claim 11, wherein the note captures a healthcare services event in the context of an insurance claim using American National Standards Group (ANSI) Accredited Standards Committee (ASC) X12N 270, 271, 276, 277, 278, 820, 834, 835 and 837 Healthcare Administrative Transactions specifications.

16. The system of claim 11, wherein the instructions that, when executed, further cause the processor to:
perform the insurance Eligibility Request/Eligibility Verification by exporting and importing ANSI 270/271 (Eligibility Request/Eligibility Verification) files to and from the insurance company.

17. The system of claim 11, wherein the instructions that, when executed, further cause the processor to:
convert the note into an insurance claim and providing the insurance claim to the insurance company by exporting and importing ANSI 837/835 (Insurance claim//claim Remittance) files to and from the insurance company.

18. The system of claim 11, wherein the note records a complete healthcare services event including its associated verification request and claim information in open source/common file formats.

19. The system of claim 11, wherein the instructions that, when executed, further cause the processor to:
track costs and details related to labs, MRIs, X-Rays, and CT scans in the note.

20. Software stored in a non-transitory computer readable medium and comprising instructions executable by a system, and in response to such execution causes the system to perform operations comprising:
receiving information for a healthcare services event for a patient and creating a note based therein;
performing an insurance Eligibility Request/Eligibility Verification by with an insurance company utilizing patient information converted into a format readable by the insurance company;
receiving information as the healthcare services event is performed to complete the note, wherein the note comprises doctor supplied procedure and diagnostic content needed to create a valid insurance claim; and
converting the note into an insurance claim and providing the insurance claim to the insurance company in a format readable by the insurance company;
wherein the note is setup to automatically convert to the insurance claim without back-end user input or coding.
